(19) United States
(12) Patent Application Publication
(10) Pub. No.: US 2006/0047444 A1
(43) Pub. Date: Mar. 2, 2006

(54) Method for analyzing an unknown material as a blend of known materials calculated so as to match certain analytical data and predicting properties of the unknown based on the calculated blend

(76) Inventors: James M. Brown, Flemington, NJ (US); Chad J. Chrostowski, Cranberry Township, PA (US)

Correspondence Address: ExxonMobil Research and Engineering Company, P.O. Box 900, Annandale, NJ, 08801-0900, US

(21) Appl. No.: 11/200,490

(22) Filed: Aug. 9, 2005

Related U.S. Application Data
(60) Provisional application No. 60/604,170, filed on Aug. 24, 2004.

(51) Int. Cl. G06F 19/00; G01N 31/00

(52) U.S. Cl. 702/30

(57) ABSTRACT

The current invention is an improvement to the method of U.S. Pat. No. 6,662,116 B2. Specifically, the current invention provides means for comparing the quality of property predictions made using different sets of known (reference) materials and different inspection inputs such that the most accurate prediction is obtained. Further, the current invention increases the flexibility of using viscosity data in the method of U.S. Pat. No. 6,662,116 B2.

This application claims the benefit of U.S. Provisional application 60/604,170 filed Aug. 24, 2004.

### BACKGROUND OF THE INVENTION

The present invention relates to a method for analyzing an unknown material using a multivariate analytical technique such as spectroscopy, or a combination of a multivariate analytical technique and inspections. In particular, the present invention relates to an improvement of such a method described in U.S. Pat. No. 6,662,116 B2.

The method of U.S. Pat. No. 6,662,116 B2 can be used to estimate crude assay type data based on FT-IR spectral measurements and inspection data. However, this method does not provide a means of estimating the uncertainty on the predicted assay estimates, nor a means of comparing the accuracy of estimates made using different sets of references or different input inspections. The method of U.S. Pat. No. 6,662,116 B describes the use of a multiple correlation coefficient (R²) to measure how well the linear combination of the reference FT-IR spectra match the spectrum of the unknown. The fit to the inspection data is separately compared to the reproducibilities of their test methods. However, no means is given for converting these three separate comparisons into an estimate of prediction uncertainties, nor for comparing quality of predictions made using different inputs.

In a refinery situation, it is not uncommon for a user of the method of U.S. Pat. No. 6,662,116 B2 to generate analyses using different combinations of inputs and/or references. Thus the user may try to use FT-IR only, FT-IR in combination with API Gravity, or FT-IR in combination with both API Gravity and viscosity. Since the use of the inspections adds additional constraints into the fit, the multiple correlation coefficient for the fit of the FT-IR spectrum will always decrease as additional inspections are added. However, the accuracy of the assay predictions will typically increase when inspections are added. Similarly, the user may initially choose to analyze an unknown using a limited set of reference crudes, and then gradually expand the set until all crudes in the library are used. As the number of references increases, the fit to the FT-IR spectrum improves (R² increases), but the accuracy of the assay predictions may remain constant, or sometimes decrease. Practical application of the method of U.S. Pat. No. 6,662,116 B2 thus requires some means of comparing these different analyses, and of estimating the uncertainty on the predictions that are produced.

The method of U.S. Pat. No. 6,662,116 B2 describes the use of Viscosity Blending Numbers to linearize viscosity data for use in the fitting algorithm. Some software packages that manipulate assay data may use alternative viscosity blending schemes that are based on viscosities measured at two or more temperatures. The viscosity/temperature relationship is established based on these multiple measurements and used to estimate a viscosity at a fixed reference temperature. For a blend, the slope of the viscosity/temperature line, and the viscosity at the fixed reference temperature are both blended, and the resultant blend slope and blend viscosity at the fixed reference temperature are used to estimate viscosity of the blend at any other temperature. The method of U.S. Pat. No. 6,662,116 B2 will not utilize these types of viscosity blending calculations, and will thus not produce viscosity estimates for blends that are consistent with software packages that do use these algorithms.

### SUMMARY OF THE INVENTION

The current invention is an improvement to the method of U.S. Pat. No. 6,662,116 B2. Specifically, the current invention provides means for comparing the quality of property predictions made using different sets of known (reference) materials and different inspection inputs such that the most accurate prediction is obtained. Further, the current invention increases the flexibility of using viscosity data in the method of U.S. Pat. No. 6,662,116 B2.

The invention of U.S. Pat. No. 6,662,116 B2 is a method for analyzing an unknown material using a multivariate analytical technique such as spectroscopy, or a combination of a multivariate analytical technique and inspections. Such inspections are physical or chemical property measurements that can be made cheaply and easily on the bulk material, and include but are not limited to API or specific gravity and viscosity. The unknown material is analyzed by comparing its multivariate analytical data (e.g. spectrum) or its multivariate analytical data and inspections to a database containing multivariate analytical data or multivariate analytical data and inspection data for reference materials of the same type. The comparison is done so as to calculate a blend of a subset of the reference materials that matches the containing multivariate analytical data or containing multivariate analytical data and inspections of the unknown. The calculated blend of the reference materials is then used to predict additional chemical, physical or performance properties of the unknown using measured chemical, physical and performance properties of the reference materials and known blending relationships.

In a preferred embodiment of U.S. Pat. No. 6,662,116 B2, FT-IR spectra are used in combination with API gravity and viscosity to predict assay data for crude oils. The FT-IR spectra of the unknown crude is augmented with the inspection data, and fit as a linear combination of augmented FT-IR spectra for reference crudes. For the invention of U.S. Pat. No. 6,662,116 B2, the viscosity data for the unknown crude must be measured at a temperature for which the viscosity data for the reference crude oils is known or can be calculated.

The method of U.S. Pat. No. 6,662,116 B2 does not provide a means of estimating the uncertainty on the predicted properties. The uncertainty on the prediction will vary depending on how well the data for the calculated blend matches (fits) the data for the unknown, depending on how many components are used in calculating the blend, and depending on which inspections are used.

The current invention estimates the uncertainty of the predicted properties in terms of a Fit Quality parameter, referred to as the Fit Quality Ratio (FQR). The Fit Quality (FQ) is a function of how well the blend fits the data for the unknown, of the number of components in the blend, and of the included inspections. The Fit Quality Ratio (FQR) is the ratio of the Fit Quality to a Fit Quality Cutoff (FQC). The current invention provides means for optimizing the Fit Quality Cutoffs and inspection weightings such that analyses that produce similar Fit Quality Ratios will also produce comparable prediction uncertainties regardless of which inspection inputs are used. FQR values calculated using different sets of known (reference) materials and/or different inspection inputs can be compared to select the analysis that produces the most certain prediction. Further, in the case where an inspection input is unavailable, the current invention allows for the estimate of the increase in the prediction uncertainty associated with making the prediction based on the reduced number of inputs.

While the method of U.S. Pat. No. 6,662,116 B2 preferably uses FT-IR, API Gravity and viscosity data for the prediction of crude assay data, for on-line application, it is desirable that the analysis continue even if one or more of the inspections is temporarily unavailable due to analyzer failure or maintenance. Since the accuracy of the assay data predictions are dependent on which inputs are used, it is desirable to have a common quality parameter that defines the quality of the predictions regardless of the inputs used in the analysis. The current invention provides such a parameter, and further provides a means of computing confidence intervals on the predicted assay data.

One of the possible inspection inputs for U.S. Pat. No. 6,662,116 B2 is a Viscosity Blending Number calculated from a viscosity measured at a single temperature. Some software packages that manipulate crude assay data employ viscosity blending algorithms that use Viscosity Indexes that are functions of viscosities measured at multiple temperatures. The current invention adapts the algorithm of U.S. Pat. No. 6,661,116 B2 so as to allow the slope of the viscosity/temperature relationship to be estimated, and thereby allow indexes based on multiple viscosities to be employed. This adaptation increases the flexibility with which the invention can be applied and the compatibility of the invention with additional assay software packages.

### BRIEF DESCRIPTION OF THE DRAWINGS

FIG. 1 shows a schematic for predicting crude assay data.

FIG. 2 shows the error in the prediction of atmospheric resid vs. fit quality.

FIG. 3 shows the predicted minus actual volume percent yield vs. sqrt (1−R²) for atmospheric resid.

FIG. 4 shows the predicted minus actual volume percent vs. FQR for atmospheric resid.

FIG. 5 shows the confidence interval for the prediction of atmospheric resid volume percent yield vs. FQR.

FIG. 6 shows the confidence interval for the prediction of weight percent sulfur vs. FQR and sulfur level.

### BRIEF DESCRIPTION OF THE PREFERRED EMBODIMENTS

Within the petrochemical industry, there are many instances where a very detailed analyses of a process feed or product is needed for the purpose of making business decisions, planning, controlling and optimizing operations, and certifying products. Herein below, such a detailed analysis will be referred to as an assay, a crude assay being one example thereof. The methodology used in the detailed analysis may be costly and time consuming to perform, and may not be amenable to real time analysis. It is desirable to have a surrogate methodology that can provide the information of the detailed analysis inexpensively and in a timely fashion. U.S. Pat. No. 6,662,116 B2 and the present invention are such surrogate methodologies.

The invention of U.S. Pat. No. 6,662,116 B2 is a method for analyzing an unknown material using a multivariate analytical technique such as spectroscopy, or a combination of a multivariate analytical technique and inspections. Such inspections are physical or chemical property measurements that can be made cheaply and easily on the bulk material, and include but are not limited to API or specific gravity and viscosity. The unknown material is analyzed by comparing its multivariate analytical data (e.g. spectrum) or its multivariate analytical data and inspections to a database containing multivariate analytical data or multivariate analytical data and inspection data for reference materials of the same type. The comparison is done so as to calculate a blend of a subset of the reference materials that matches the containing multivariate analytical data or containing multivariate analytical data and inspections of the unknown. The calculated blend of the reference materials is then used to predict additional chemical, physical or performance properties of the unknown using measured chemical, physical and performance properties of the reference materials and known blending relationships.

While the preferred embodiment of the present invention utilizes extended mid-infrared spectroscopy (7000-400 cm⁻¹), similar results could potentially be obtained using other multivariate analytical techniques. Such multivariate analytical techniques include other forms of spectroscopy including but not limited to near-infrared spectroscopy (12500-7000 cm⁻¹), UV/visible spectroscopy (200-800 nm), fluorescence and NMR spectroscopy. Similar analyses could also potentially be done using data derived multivariate analytical techniques such as simulated gas chromatographic distillation (GCD) and mass spectrometry or from combined multivariate analytical techniques such as GC/MS. In this context, the use of the word spectra herein below includes any vector or array of analytical data generated by a multivariate analytical measurement such as spectroscopy, chromatography or spectrometry or their combinations.

In a preferred embodiment of U.S. Pat. No. 6,662,116 B2, FT-IR spectra are used in combination with API gravity and viscosity to predict assay data for crude oils. The FT-IR spectra of the unknown crude is augmented with the inspection data, and fit as a linear combination of augmented FT-IR spectra for reference crudes. This preferred embodiment of U.S. Pat. No. 6,662,116 B2 can be expressed mathematically as [1].

$$\begin{matrix}min ( {( [ \begin{matrix}{\hat{x}}_{u} \\ {w}_{API} {\hat{λ}}_{{}_{u} ( API )} \\ {w}_{Visc} {\hat{λ}}_{{}_{u} ( Visc )}\end{matrix} ] - [ \begin{matrix}{x}_{u} \\ {w}_{API} {λ}_{{}_{u} ( API )} \\ {w}_{Visc} {λ}_{{}_{u} ( Visc )}\end{matrix} ] )}^{T} ( [ \begin{matrix}{\hat{x}}_{u} \\ {w}_{API} {\hat{λ}}_{{}_{u} ( API )} \\ {w}_{Visc} {\hat{λ}}_{{}_{u} ( Visc )}\end{matrix} ] - [ \begin{matrix}{x}_{u} \\ {w}_{API} {λ}_{{}_{u} ( API )} \\ {w}_{Visc} {λ}_{{}_{u} ( Visc )}\end{matrix} ] ) ) & [ 1 a ] \\ \begin{matrix}where & {\hat{x}}_{u} = X {c}_{u} , & {\hat{λ}}_{{}_{u} ( API )} = {Λ}_{( API )} {c}_{u} , & and & {\hat{λ}}_{{}_{u} ( visc )} = {Λ}_{( visc )} {c}_{u}\end{matrix} & [ 1 b ]\end{matrix}$$

xᵤ is a column vector containing the FT-IR for the unknown crude, and X is the matrix of FT-IR spectra of the reference crudes. The FT-IR spectra are measured on a constant volume of crude oil, so they are blended on a volumetric basis. Both xᵤ and X may have been orthogonalized to corrections as described in U.S. Pat. No. 6,662,116 B2. xᵤ is augmented by adding two additional elements to the bottom of the column, w_{API}λᵤ(API), and w_{Visc}λᵤ(Visc). λᵤ(api) and λᵤ(visc) are the volumetrically blendable versions of the API gravity and viscosity inspections for the unknown, and Λ_{(API)} and Λ_{(visc)} are the corresponding volumetrically blendable inspections for the reference crudes. w_{API} and w_{visc} are the weighting factors for the two inspections. The \hat{x}ᵤ and \hat{λ}ᵤ values are the estimates of the spectrum and inspections based on the calculated linear combination with coefficients cᵤ. The linear combination is preferably calculated using a nonnegative least squares algorithm.

In U.S. Pat. No. 6,662,116 B2, the viscosity data used in calculating λᵤ(visc) and Λ_{(visc)} must be measured at the same temperature, and are converted to a Viscosity Blending Number using the relationship
VBN=a+b log(log(v+c)) [2]

For viscosities above 1.5 cSt, the parameter c is in the range of 0.6 to 0.8. For viscosities less than 1.5, c is typically expressed as a function of viscosity. A suitable function for c is given by:
c=0.098865v⁴−0.49915v³+0.99067v²−0.96318v+0.99988

For the purpose of U.S. Pat. No. 6,662,116 B2 and this invention, the parameter a is set to 0 and the parameter b is set to 1. If viscosities are assumed to blend on a weight basis, the VBN calculated from [13] would be multiplied by the specific gravity of the material to obtain a volumetrically blendable number. The method used to obtain volumetrically blendable numbers would typically be chosen to match that used by the program that manipulates the data from the detailed analysis to produce assay predictions.

If viscosity data for the reference crudes is not available at the temperature for which the viscosity is measured for the unknown, then equation [1] cannot be directly applied.

For crude oils, ASTM D341 (see Annual Book of ASTM Standards, Volumes 5.01-5.03, American Society for Testing and Materials, Philadelphia, Pa.) describes the temperature dependence of viscosity. An alternate way of expressing this relationship is given by [4].
VBN(T)=log(log(v(T)+c))=A+B log T [4]
T is the absolute temperature in ° C. or ° R. The parameters A and B are calculated based on fitting [4] for viscosities measured at two or more temperatures.

If the viscosity of the unknown is not measured at a temperature for which viscosity data was measured for the reference crudes, then two alternatives can be applied. First, equation [4] can be applied to the viscosity data for the reference crudes to calculate v_{references} at the temperature at which the unknown's viscosity was measured. The calculated viscosities for the references are then used to calculate Λ_{(visc)}, and equation [1] is applied. Alternatively, the slope, B, in [2] can be estimated based on the analysis of the FT-IR spectrum, or the FT-IR spectrum and API Gravity, and B can be used in combination with the measured viscosity to estimate a viscosity of the unknown at a common reference temperature.

The following algorithmic method has been found to offer advantages for the analysis on unknowns:

Step 1:

In step 1, no inspection data is used.
min((\hat{x}ᵢ−xᵤ)^{T}(\hat{x}ᵤ−xᵤ)) [5]
where \hat{x}ᵤ=Xcₛₜₑₚ₁

Equation [4] is applied to nonaugmented spectral data to calculate a linear combination that matches the FT-IR spectrum of the unknown. A non-negative least squares algorithm is preferably used to calculate the coefficients cₛₜₑₚ₁. The sum of the coefficients is calculated, and a scaling factor, s, is calculated as the reciprocal of the sum. The coefficients are scaled by the scaling factor. The unknown spectrum is also scaled by the scaling factor. An R² value is calculated using [6].

$${R}_{step1}^{2} = 1 - \frac{{( {\hat{x}}_{u} - s {x}_{u} )}^{T} ( {\hat{x}}_{u} - s {x}_{u} ) / ( f - c - 1 )}{{( s {x}_{u} - \overline{s {x}_{u}} )}^{T} ( s {x}_{u} - \overline{s {x}_{u}} ) / ( f - 1 )} \qquad [ 6 ]$$

f is the number of points in the spectra vector xᵤ, and c is the number of non-zero coefficients from the fit. Other goodness-of-fit statistics could be used in place of R².
Step 2:

In step 2, the scaled spectrum from step 1 is augmented with the volumetrically blendable version of the API gravity data (i.e. specific gravity) to form vector

$$[ \begin{matrix}s {x}_{u} \\ {w}_{API} {λ}_{{}_{u} ( API )}\end{matrix} ] .$$

An estimate of the augmented vector,

$$[ \begin{matrix}{\hat{x}}_{u} \\ {w}_{API} {\hat{λ}}_{{}_{u} ( API )}\end{matrix} ] ,$$

is calculated from the coefficients from step 1, and the relationships in equation [1b]. An initial R² value is calculated using [7].

$${R}_{step2}^{2} = 1 - \frac{{( [ \begin{matrix}{\hat{x}}_{u} \\ {w}_{API} {\hat{λ}}_{{}_{u} ( API )}\end{matrix} ] - [ \begin{matrix}s {x}_{u} \\ {w}_{API} {λ}_{{}_{u} ( API )}\end{matrix} ] )}^{T} ( [ \begin{matrix}{\hat{x}}_{u} \\ {w}_{API} {\hat{λ}}_{{}_{u} ( API )}\end{matrix} ] - [ \begin{matrix}s {x}_{u} \\ {w}_{API} {λ}_{{}_{u} ( API )}\end{matrix} ] ) / ( f + 1 - c - 1 )}{{( [ \begin{matrix}s {x}_{u} \\ {w}_{API} {λ}_{{}_{u} ( API )}\end{matrix} ] - \overline{[ \begin{matrix}s {x}_{u} \\ {w}_{API} {λ}_{{}_{u} ( API )}\end{matrix} ]} )}^{T} ( [ \begin{matrix}s {x}_{u} \\ {w}_{API} {λ}_{{}_{u} ( API )}\end{matrix} ] - \overline{[ \begin{matrix}s {x}_{u} \\ {w}_{API} {λ}_{{}_{u} ( API )}\end{matrix} ]} ) / ( f + 1 - 1 )} \qquad [ 7 ]$$

$$[ \begin{matrix}s {x}_{u} \\ {w}_{API} {λ}_{{}_{u} ( API )}\end{matrix} ]$$

is a vector of the same length as vector

$$[ \begin{matrix}s {x}_{u} \\ {w}_{API} {λ}_{{}_{u} ( API )}\end{matrix} ] ,$$

all of whose elements are the average of the elements in the vector

$$[ \begin{matrix}s {x}_{u} \\ {w}_{API} {λ}_{{}_{u} ( API )}\end{matrix} ] .$$

The scaled, augmented spectral vector is then fit using

$$\begin{matrix}min ( {( [ \begin{matrix}{\hat{x}}_{u} \\ {w}_{API} {\hat{λ}}_{{}_{u} ( API )}\end{matrix} ] - [ \begin{matrix}s {x}_{u} \\ {w}_{API} {λ}_{{}_{u} ( API )}\end{matrix} ] )}^{T} ( [ \begin{matrix}{\hat{x}}_{u} \\ {w}_{API} {\hat{λ}}_{{}_{u} ( API )}\end{matrix} ] - [ \begin{matrix}s {x}_{u} \\ {w}_{API} {λ}_{{}_{u} ( API )}\end{matrix} ] ) ) & [ 8 a ] \\ \begin{matrix}where & {\hat{x}}_{u} = X {c}_{step2} , & and & {\hat{λ}}_{{}_{u} ( API )} = {Λ}_{( API )} {c}_{step2}\end{matrix} & [ 8 b ]\end{matrix}$$

The coefficients, cₛₜₑₚ₂ calculated from the preferably nonnegative least squares fit are summed, and a new scaling factor, s, is calculated as the reciprocal of the sum times the previous scaling factor. The coefficients are scaled to sum to unity, and the estimate,

$$[ \begin{matrix}{\hat{x}}_{u} \\ {w}_{API} {\hat{λ}}_{{}_{u} ( API )}\end{matrix} ] ,$$

of the augmented spectral vector is recalculated based on these normalized coefficients and [8b]. An R² value is again calculated using [7] and the new scaling factor. If the new R² value is greater than the previous value, the new fit is accepted. Equations [8] are again applied using the newly calculated scaling factor. The process continues until no further increase in the calculated R² value is obtained.
Step 3 Using Viscosity Blending Numbers

If a viscosity blending number based on viscosity measured at a single fixed temperature is to be used, then in step 3, the scaled, augmented spectral vector from step 2 that gave the best R² value is further augmented with the volumetrically blendable version of the viscosity data to form vector

$$[ \begin{matrix}s {x}_{u} \\ {w}_{API} {λ}_{{}_{u} ( API )} \\ {w}_{Visc} {λ}_{{}_{u} ( Visc )}\end{matrix} ] .$$

Estimates of the augmented vector,

$$[ \begin{matrix}{\hat{x}}_{u} \\ {w}_{API} {\hat{λ}}_{{}_{u} ( API )} \\ {w}_{Visc} {\hat{λ}}_{{}_{u} ( Visc )}\end{matrix} ] ,$$

are calculated using the cₛₜₑₚ₂, and the relationships in equation [1b]. An initial R² value is calculated using [9].

$${R}_{step3}^{2} = 1 - \frac{{( [ \begin{matrix}{\hat{x}}_{u} \\ {w}_{API} {\hat{λ}}_{{}_{u} ( API )} \\ {w}_{Visc} {\hat{λ}}_{{}_{u} ( Visc )}\end{matrix} ] - [ \begin{matrix}s {x}_{u} \\ {w}_{API} {λ}_{{}_{u} ( API )} \\ {w}_{Visc} {λ}_{{}_{u} ( Visc )}\end{matrix} ] )}^{T} ( [ \begin{matrix}{\hat{x}}_{u} \\ {w}_{API} {\hat{λ}}_{{}_{u} ( API )} \\ {w}_{Visc} {\hat{λ}}_{{}_{u} ( Visc )}\end{matrix} ] - [ \begin{matrix}s {x}_{u} \\ {w}_{API} {λ}_{{}_{u} ( API )} \\ {w}_{Visc} {λ}_{{}_{u} ( Visc )}\end{matrix} ] ) / ( f + 2 - c - 1 )}{{( [ \begin{matrix}s {x}_{u} \\ {w}_{API} {λ}_{{}_{u} ( API )} \\ {w}_{Visc} {λ}_{{}_{u} ( Visc )}\end{matrix} ] - \overline{[ \begin{matrix}s {x}_{u} \\ {w}_{API} {λ}_{{}_{u} ( API )} \\ {w}_{Visc} {λ}_{{}_{u} ( Visc )}\end{matrix} ]} )}^{T} ( [ \begin{matrix}s {x}_{u} \\ {w}_{API} {λ}_{{}_{u} ( API )} \\ {w}_{Visc} {λ}_{{}_{u} ( Visc )}\end{matrix} ] - \overline{[ \begin{matrix}s {x}_{u} \\ {w}_{API} {λ}_{{}_{u} ( API )} \\ {w}_{Visc} {λ}_{{}_{u} ( Visc )}\end{matrix} ]} ) / ( f + 2 - 1 )} \qquad [ 9 ]$$

$$[ \begin{matrix}s {x}_{u} \\ {w}_{API} {λ}_{{}_{u} ( API )} \\ {w}_{Visc} {λ}_{{}_{u} ( Visc )}\end{matrix} ]$$

is a vector of the same length as

$$[ \begin{matrix}s {x}_{u} \\ {w}_{API} {λ}_{{}_{u} ( API )} \\ {w}_{Visc} {λ}_{{}_{u} ( Visc )}\end{matrix} ] ,$$

whose elements are the average of the elements in

$$[ \begin{matrix}s {x}_{u} \\ {w}_{API} {λ}_{{}_{u} ( API )} \\ {w}_{Visc} {λ}_{{}_{u} ( Visc )}\end{matrix} ]$$

The scaled, augmented spectral vector is then fit using

$$\begin{matrix}min ( {( [ \begin{matrix}{\hat{x}}_{u} \\ {w}_{API} {\hat{λ}}_{{}_{u} ( API )} \\ {w}_{Visc} {\hat{λ}}_{{}_{u} ( Visc )}\end{matrix} ] - [ \begin{matrix}s {x}_{u} \\ {w}_{API} {λ}_{{}_{u} ( API )} \\ {w}_{Visc} {λ}_{{}_{u} ( Visc )}\end{matrix} ] )}^{T} ( [ \begin{matrix}{\hat{x}}_{u} \\ {w}_{API} {\hat{λ}}_{{}_{u} ( API )} \\ {w}_{Visc} {\hat{λ}}_{{}_{u} ( Visc )}\end{matrix} ] - [ \begin{matrix}s {x}_{u} \\ {w}_{API} {λ}_{{}_{u} ( API )} \\ {w}_{Visc} {λ}_{{}_{u} ( Visc )}\end{matrix} ] ) ) & [ 10 a ] \\ \begin{matrix}where & {\hat{x}}_{u} = X {c}_{step3} , & \hat{λ} {}_{{}_{u} ( API )} = {Λ}_{( API )} {c}_{step3} , & and & {\hat{λ}}_{{}_{u} ( visc )} = {Λ}_{( visc )} {c}_{u}\end{matrix} & [ 10 b ]\end{matrix}$$

The coefficients, cₛₜₑₚ₃ calculated from the preferably nonnegative least squares fit are summed, and a new scaling factor, s, is calculated as the reciprocal of the sum times the previous scaling factor. The coefficients are scaled to sum to unity, and the estimate,

$$[ \begin{matrix}{\hat{x}}_{u} \\ {w}_{API} {\hat{λ}}_{{}_{u} ( API )} \\ {w}_{Visc} {\hat{λ}}_{{}_{u} ( Visc )}\end{matrix} ] ,$$

of the augmented spectral vector is recalculated based on these normalized coefficients and [10b]. An R² value is again calculated using [9] and the new scaling factor. If the new R² value is greater than the previous value, the new fit is accepted. Equations [10a] and [10b] are again applied using the newly calculated scaling factor. The process continues until no further increase in the calculated R² value is obtained. A “virtual blend” of the reference crudes is calculated based on the final cₛₜₑₚ₃ coefficients, and assay properties are predicted using known blending relationships as described in U.S. Pat. No. 6,662,116 B2.
Step 2 if API Gravity is Unavailable:

If API gravity is unavailable, in step 2, the scaled spectrum from step 1 is augmented with the volumetrically blendable version of the viscosity data to form vector

$$[ \begin{matrix}s {x}_{u} \\ {w}_{Visc} {λ}_{{}_{u} ( Visc )}\end{matrix} ] .$$

An estimate of the augmented vector,

$$[ \begin{matrix}{\hat{x}}_{u} \\ {w}_{Visc} {\hat{λ}}_{{}_{u} ( Visc )}\end{matrix} ] ,$$

is calculated from the coefficients from step 1, and the relationships in equation [1b]. An initial R² value is calculated using [11].

$${R}^{2} = 1 - \frac{{( [ \begin{matrix}{\hat{x}}_{u} \\ {w}_{Visc} {\hat{λ}}_{{}_{u} ( Visc )}\end{matrix} ] - [ \begin{matrix}s {x}_{u} \\ {w}_{Visc} {λ}_{{}_{u} ( Visc )}\end{matrix} ] )}^{T} ( [ \begin{matrix}{\hat{x}}_{u} \\ {w}_{Visc} {\hat{λ}}_{{}_{u} ( Visc )}\end{matrix} ] - [ \begin{matrix}s {x}_{u} \\ {w}_{Visc} {λ}_{{}_{u} ( Visc )}\end{matrix} ] ) / ( f + 1 - c - 1 )}{{( [ \begin{matrix}s {x}_{u} \\ {w}_{Visc} {λ}_{{}_{u} ( Visc )}\end{matrix} ] - \overline{[ \begin{matrix}s {x}_{u} \\ {w}_{Visc} {λ}_{{}_{u} ( Visc )}\end{matrix} ]} )}^{T} ( [ \begin{matrix}s {x}_{u} \\ {w}_{Visc} {λ}_{{}_{u} ( Visc )}\end{matrix} ] - \overline{[ \begin{matrix}s {x}_{u} \\ {w}_{Visc} {λ}_{{}_{u} ( Visc )}\end{matrix} ]} ) / ( f + 1 - 1 )} \qquad [ 11 ]$$

$$[ \begin{matrix}s {x}_{u} \\ {w}_{Visc} {λ}_{{}_{u} ( Visc )}\end{matrix} ]$$

is a vector of the same length as

$$[ \begin{matrix}s {x}_{u} \\ {w}_{Visc} {λ}_{{}_{u} ( Visc )}\end{matrix} ] ,$$

whose elements are the average of the elements in

$$[ \begin{matrix}s {x}_{u} \\ {w}_{Visc} {λ}_{{}_{u} ( Visc )}\end{matrix} ] .$$

The scaled, augmented spectral vector is then fit

$$\begin{matrix}using min ( {( [ \begin{matrix}{\hat{x}}_{u} \\ {w}_{Visc} {\hat{λ}}_{{}_{u} ( Visc )}\end{matrix} ] - [ \begin{matrix}s {x}_{u} \\ {w}_{Visc} {λ}_{{}_{u} ( Visc )}\end{matrix} ] )}^{T} ( [ \begin{matrix}{\hat{x}}_{u} \\ {w}_{Visc} {\hat{λ}}_{{}_{u} ( Visc )}\end{matrix} ] - [ \begin{matrix}s {x}_{u} \\ {w}_{Visc} {λ}_{{}_{u} ( Visc )}\end{matrix} ] ) ) & [ 12 a ] \\ \begin{matrix}where & {\hat{x}}_{u} = X {c}_{step2} , & and & {\hat{λ}}_{{}_{u} ( Visc )} = {Λ}_{( Visc )} {c}_{step2}\end{matrix} & [ 12 b ]\end{matrix}$$

The coefficients, cₛₜₑₚ₂ calculated from the preferably nonnegative least squares fit are summed, and a new scaling factor, s, is calculated as the reciprocal of the sum times the previous scaling factor. The coefficients are scaled to sum to unity, and the estimate,

$$[ \begin{matrix}{\hat{x}}_{u} \\ {w}_{Visc} {\hat{λ}}_{{}_{u} ( Visc )}\end{matrix} ] ,$$

of the augmented spectral vector is recalculated based on these normalized coefficients and [12b]. An R² value is again calculated using [11] and the new scaling factor. If the new R² value is greater than the previous value, the new fit is accepted. Equations [12a] and [12b] are again applied using the newly calculated scaling factor. The process continues until no further increase in the calculated R² value is obtained. A “virtual blend” of the reference crudes is calculated based on the final cₛₜₑₚ₂ coefficients, and assay properties are predicted using known blending relationships as described in U.S. Pat. No. 6,662,116 B2.
Step 3 Alternative:

In step 3 above, viscosity data for the references must be known or calculable at the temperature at which the viscosity for the unknown is measured. Alternatively, the viscosity/temperature slop, B, can be estimated and used to calculate the viscosity at a fixed temperature for which viscosity data for reference crudes is known.

The viscosity/temperature slope for the unknown, \hat{B}ᵤ, is estimated as the blend of the viscosity/temperature slopes of the reference crudes using the coefficients cₛₜₑₚ₂ from step 2. If the slopes are blended on a weight basis, the cₛₜₑₚ₂ coefficients are converted to their corresponding weight percentages using the specific gravities of the references. The estimated slope, \hat{B}ᵤ, the viscosity for the unknown, vᵤ, and the temperature at which the viscosity was measured, Tᵤ are used to calculate the viscosity, Vᵤ(T_{f}) at a fixed temperature T_{f} using relationship [13].

$$log ( log ( {v}_{{}_{u} ( {T}_{f} )} + c ) ) = log ( log ( {v}_{u} + c ) ) + B log ( \frac{{T}_{f}}{{T}_{u}} ) \qquad [ 13 ]$$

The vᵤ(T_{f}) value is used to calculate a volumetrically blendable viscosity value, λᵤ, for use in

$$[ \begin{matrix}s {x}_{u} \\ {w}_{API} {λ}_{{}_{u} ( API )} \\ {w}_{Visc} {λ}_{{}_{u} ( Visc )}\end{matrix} ] .$$

Each time new coefficients cₛₜₑₚ₃ are calculated, the slope \hat{B}ᵤ is reestimated based on the new blend and used to calculate new values of vᵤ(T_{f}) and λᵤ for use in calculating a new R² via equation [9].
Step 2 Alternative if API Gravity is Unavailable:

If API gravity is unavailable, the procedure described above under Step 3 Alternative is applied using the coefficients cₛₜₑₚ₁ to estimate the viscosity/temperature slope in the calculation of vᵤ(T_{f}).

Incorporation of Additional Inspection Data:

Other inspections in addition to API gravity and viscosity can optionally be used in the calculation. The volumetrically blendable form of the data for these inspections are included in the augmented vector in Step 2 along with the viscosity data to form an augmented vector

$$[ \begin{matrix}s {x}_{u} \\ {w}_{API} {λ}_{{}_{u} ( API )} \\ {w}_{Inspection1} {λ}_{{}_{u} ( Inspection1 )} \\ ⋮ \\ {w}_{InspectionLast} {λ}_{{}_{u} ( InspectionLast )}\end{matrix} ] .$$

The calculations then proceed as described above. At each step in the calculations, the predictions of the additional inspections are given by [14]
\hat{μ}ᵤ(Inspection)=Λ(Inspection)c [14]

Other inspections that might be included include, but are not limited to, sulfur, nitrogen, and acid number. The value of R² would be calculated as:

$${R}_{step3}^{2} = 1 - \frac{\frac{{( [ \begin{matrix}{\hat{x}}_{u} \\ {w}_{API} {\hat{λ}}_{{}_{u} ( API )} \\ {w}_{Inspection1} {\hat{λ}}_{{}_{u} ( Inspection1 )} \\ ⋮ \\ {w}_{InspectionLast} {\hat{λ}}_{{}_{u} ( InspectionLast )}\end{matrix} ] - [ \begin{matrix}s {x}_{u} \\ {w}_{API} {λ}_{{}_{u} ( API )} \\ {w}_{Inspection1} {λ}_{{}_{u} ( Inspection1 )} \\ ⋮ \\ {w}_{InspectionLast} {λ}_{{}_{u} ( InspectionLast )}\end{matrix} ] )}^{T} ( \begin{matrix}{\hat{x}}_{u} \\ {w}_{API} {\hat{λ}}_{{}_{u} ( API )} \\ {w}_{Inspection1} {\hat{λ}}_{{}_{u} ( Inspection1 )} \\ ⋮ \\ {w}_{InspectionLast} {\hat{λ}}_{{}_{u} ( InspectionLast )}\end{matrix} - [ \begin{matrix}s {x}_{u} \\ {w}_{API} {λ}_{{}_{u} ( API )} \\ {w}_{Inspection1} {λ}_{{}_{u} ( Inspection1 )} \\ ⋮ \\ {w}_{InspectionLast} {λ}_{{}_{u} ( InspectionLast )}\end{matrix} ] )}{( f + i - c - 1 )}}{\frac{{( [ \begin{matrix}s {x}_{u} \\ {w}_{API} {λ}_{{}_{u} ( API )} \\ {w}_{Inspection1} {λ}_{{}_{u} ( Inspection1 )} \\ ⋮ \\ {w}_{InspectionLast} {λ}_{{}_{u} ( InspectionLast )}\end{matrix} ] - \overline{[ \begin{matrix}s {x}_{u} \\ {w}_{API} {λ}_{{}_{u} ( API )} \\ {w}_{Inspection1} {λ}_{{}_{u} ( Inspection1 )} \\ ⋮ \\ {w}_{InspectionLast} {λ}_{{}_{u} ( InspectionLast )}\end{matrix} ]} )}^{T} ( [ \begin{matrix}s {x}_{u} \\ {w}_{API} {λ}_{{}_{u} ( API )} \\ {w}_{Inspection1} {λ}_{{}_{u} ( Inspection1 )} \\ ⋮ \\ {w}_{InspectionLast} {λ}_{{}_{u} ( InspectionLast )}\end{matrix} ] - \overline{[ \begin{matrix}s {x}_{u} \\ {w}_{API} {λ}_{{}_{u} ( API )} \\ {w}_{Inspection1} {λ}_{{}_{u} ( Inspection1 )} \\ ⋮ \\ {w}_{InspectionLast} {λ}_{{}_{u} ( InspectionLast )}\end{matrix} ]} )}{( f + i - 1 )}} \qquad [ 15 ]$$

i is the number of inspections used.
Volumentrically Blendable Viscosity

The volumetrically blendable version of API gravity is specific gravity. If API gravity is used as input into the current invention, it is converted to specific gravity prior to use. Viscosity data is also converted to a volumetrically blendable form. U.S. Pat. No. 6,662,116 B2 describes several methods that can be used to convert viscosity to a blendable form. The current invention also provides for the use of a Viscosity Blending Index (VBI). The VBI is based on the viscosity at 210° F. For reference crudes, the viscosity at 210° F. is calculated based on viscosities measured at two or more temperatures and the application of equations [4] and [13]. For unknowns, the T^{f} value used in the alternative step 3 is chosen as 210° F. The Viscosity Blending Index is related to the viscosity at 210° F. by equation [14].

$${v}_{{210}^{o} F} = exp ( 0.0000866407 \cdot {VBI}^{6} - 0.00422424 \cdot {VBI}^{5} + .0671814 \cdot {VBI}^{4} - 0.541037 \cdot {VBI}^{3} + 2.65449 \cdot {VBI}^{2} + 8.95171 \cdot VBI + 16.80023 ) \qquad [ 16 ]$$

The VBI value corresponding to a given viscosity can be found from [10] using standard scalar nonlinear function minimization routines such as the fminbnd function in MATLAB® (Mathworks, Inc.).
Weighting of Inspection Data:

The inspection data used in steps 2 and 3 in the above algorithms is weighted as described in U.S. Pat. No. 6,662,116 B2. Specifically, the weight, W, has the form [17].

$$w = \frac{2.77 \cdot α \cdot ɛ}{R} \qquad [ 17 ]$$

R is the reproducibility of the inspection data calculated at the level for the unknown being analyzed. ε is the average per point variance of the corrected reference spectra in X. For crude spectra collected in a 0.2-0.25 mm cell, ε can be assumed to be 0.005. α is an adjustable parameter. α is chosen to obtain the desired error distribution for the prediction of the inspection data from steps 2 and 3.

Since the magnitude of the viscosity data changes with temperature, its contribution to the fit in steps 3 or alternative step 2 will also change. Thus the adjustable parameter for the weighting must be adjusted to obtain comparable results when using viscosity data at different temperatures. Because of interactions between the inspection data when more than one inspection is included in a fit, all of the weightings will depend on the viscosity measurement temperature, T.

$$w ( T ) = \frac{2.77 \cdot α ( T ) \cdot ɛ}{R} \qquad [ 18 ]$$

The values of α are determined at each viscosity measurement temperature using a cross-validation analysis where each reference crude is taken out of X and treated as an unknown, xᵤ.

Prediction Quality

Predictions made using different inspection inputs, or different sets of references will differ. Inspection data is included in the analysis only if it improves the prediction of some assay data. However, it is useful to be able to compare the quality of predictions made using different inspection inputs, and/or different sets of references. For laboratory application, such comparisons can be used as a check on the quality of the inspection data. For online application, analyzers used to generate inspection data may be temporarily unavailable do to failure or maintenance, and it is desirable to know how the absence of the inspection data influences the quality of the predictions.

For the purpose of comparing predictions made using different subsets of inspection data, it is preferable to have a single quality parameter that represents the overall quality of the predicted data. Given the large number of assay properties that can be predicted, it is impractical to represent the quality of all possible predictions. However, for a set of key properties, a single quality parameter can be defined.

The Fit Quality (FQ) is defined by [19].
FQ=f(c, f, i)\sqrt{1−R²} [19]
f (c, f, i) is a function of the number on nonzero coefficients in the fit, c, the number of spectral points, f, and the number of inspections used, i. For the application of this invention to the prediction of crude assay data, an adequate funtion has been found to be of the form
FQ=c^{ε}\sqrt{1−R²} [20]
The ε exponent is preferably on the order of 0.25. FQ is calculated from the R² value at each step in the calculation. A Fit Quality Cutoff (FQC_{IR}) is defined for the results from Step 1 of the calculations, i.e. for the analysis based on only the FT-IR spectra. The FQC_{IR} is selected based on some minimum performance criteria. A Fit Quality Ratio is then defined by [16].

$${FQR}_{IR} = \frac{FQ}{{FQC}_{IR}} \qquad [ 21 ]$$

For steps 2 and 3 in the algorithm, FQC_{IR,API} and FQC_{IR,API,Visc.} cutoffs are also defined. These cutoffs are determined by an optimization procedure designed to match as closely as possible the accuracy of predictions made using the different inputs. The cutoffs are used to define FQR_{IR,API} and FQR_{IR,API,Visc}.

These FQR values are the desired quality parameters that allows analyses made using different inspection inputs and different reference subsets to be compared. Generally, analyses that produce lower FQR values can be expected to produce generally more accurate predictions. Similarly, two analyses made using different inspection inputs or different reference subsets that produce fits of the same FQR are expected to produce assay predictions of similar accuracy.

The values of FQC_{IR,API} and FQC_{IR,API,Visc} are also set based on performance criteria. A critical set of assay properties is selected. For the assay predictions from step 2 (FT-IR and API Gravity) and step 3 (FT-IR, API Gravity and viscosity), the FQC value is selected such that the predictions for samples with FQR values less than or equal to 1 will be comparable to those obtained from step 1 (FT-IR only). The weightings for inspections are simultaneously adjusted such that the prediction errors for the inspections match the expected errors for their test methods. The FQC values and inspection weightings can be adjusted using standard optimization procedures.

Analyses that produce FQR values less than or equal to 1 are referred to as Tier 1 fits. Analyses that produce FQR values greater than 1, but less than or equal to 1.5 are referred to as Tier 2 fits.

Confidence Intervals:

In determining if a particular assay prediction is adequate for use in a process application, it is useful to provide an estimate of the uncertainty on the prediction. The Confidence Interval expresses the expected agreement between a predicted property for the unknown, and the value that would be obtained if the unknown were subjected to the reference analysis. The confidence intervals for each property is estimated as a function of FQR

The general form for the confidence interval is:
CI=t·s·\sqrt{FQR²+f(E_{ref})²} [22]
f(E_{ref}) is a function of the error in the reference property measurement. t is the t-statistic for the selected probability level and the number of degrees of freedom in the CI calculation. s is the standard deviation of the prediction residuals once the FQR and reference property error dependence is removed.
For application of this invention to the prediction of crude assay data, the following forms of the confidence interval have been found to provide useful estimates of prediction error:

$$\begin{matrix}Absolute Error CI \text{:} & [ 23 ] \\ \vert \hat{y} - y \vert \leq {CI}_{abs} = t \cdot s \cdot \sqrt{{FQR}^{2} + {( a + b ( \frac{\hat{y} + y}{2} ) )}^{2}} & \\ Relative Error CI \text{:} & [ 24 ] \\ \vert \frac{\hat{y} - y}{( \hat{y} + y ) / 2} \vert \leq {CI}_{rel} = t \cdot s \cdot \sqrt{{FQR}^{2} + {a}^{2}} & \end{matrix}$$

a and b are parameters that are calculated to fit the error distributions obtained during a cross-validation analysis of the reference data.
y is a measured assay property, and y is the corresponding predicted property. Which CI is applied depends on the error characteristics of the reference method. For property data where the reference method error is expected to be independent of property level, Absolute Error CI is used, and parameter b is zero. For property data where the reference method error is expected to be directly proportional to the property level, Relative Error CI is used. For property data where the reference method error is expected to depend on, but not be directly proportional to the property level, Absolute Error CI is used and both a and b can be nonzero.

For inspection data that is included in the fit, the Confidence Intervals take a slightly different form.

$$\begin{matrix}Absolute Error CI for inspections \text{:} & [ 25 ] \\ \vert \hat{y} - y \vert \leq {CI}_{abs} = t \cdot s \cdot \sqrt{1 - {R}^{2}} & \\ Relative Error CI for inspections \text{:} & [ 26 ] \\ \vert \frac{\hat{y} - y}{( \hat{y} + y ) / 2} \vert \leq {CI}_{rel} = t \cdot s \cdot \sqrt{1 - {R}^{2}} & \end{matrix}$$

Equation [25] applies to inspections such as API Gravity where the reference method error is independent of the property level. Equation [26] applies to inspections such as viscosity where the reference method error is directly proportional to the property level.
Analyses Using Reference Subsets:

When the current invention is applied to the analysis of crude oils for the prediction of crude assay data, it is desirable to limit the references used in the analysis to crudes that are most similar to the unknown being analyzed, providing that the quality of the resultant fit and predictions are adequate. Subsets of various sizes can be tested based on their similarity to the unknown. For crude oils, the following subset definitions have been found to be useful:

| Subset | Includes |
|---|---|
| Specific | User selected references |
| Reference(s) | |
| Same Grade(s) | References of the same grade(s) as the unknown |
| Same | References from the same general |
| Location(s) | geographic location(s) (country or |
| | state) as the unknown |
| Same Region(s) | References from the same general |
| | geographic region(s) as the |
| | unknown |
| All Crudes | All crude references in the library |

If, during the analysis of an unknown crude, a Tier 1 fit is obtained using a smaller subset, then the following advantages are realized:
The Virtual Blend produced by the analysis will have fewer components, simplifying and speeding the calculation of the assay property data;
The assay predictions for trace level components, which are not directly sensed by the multivariate analytical or inspection measurements may be improved;
The analysis is based on a Virtual Blend of crudes with which the end user (the refiner) may be more familiar.

Subsets could also be based on geochemical information instead of geographical information. For application to process streams, subsets could be based on the process history of the samples.

If the sample being analyzed is a mixture, the subsets may consist of samples of the grades, locations and regions as the expected crude components in the mixture.

Contaminants:

The references used in the analysis can include common contaminants that may be observed in the samples being analyzed. Typically, such contaminants are materials that are not normally expected to be present in the unknown, which are detectable and identifiable by the multivariate analytical measurement. Acetone is an example of a contaminant that is observed in the FT-IR spectra of some crude oils, presumably due to contamination of the crude sampling container.

Reference spectra for the contaminants are typically generated by difference. A crude sample is purposely contaminated. The spectrum of the uncontaminated crude is subtracted from the spectrum of the purposely-contaminated sample to generate the spectrum of the contaminant. The difference spectrum is then scaled to represent the pure material. For example, if the contaminant is added at 0.1%, the difference spectrum will be scaled by 1000.

Contaminants are tested as references in the analysis only when Tier 1 fits are not obtained using only crudes as references. If the inclusion of contaminants as references produces a Tier 1 fit when a Tier 1 fit was not obtained without the contaminant, then the sample is assumed to be contaminated.

Inspection data is calculated for the Virtual Blend including and excluding the contaminant. If the change in the calculated inspection data is greater than one half of the reproducibility of the inspection measurement method, then the sample is considered to be too contaminated to accurately analyze. If the change in the calculated inspection data is less than one half of the reproducibility of the inspection measurement method, then the assay results based on the Virtual Blend without the contaminant are assumed to be an accurate representation of the sample.

Alternatively, a maximum allowable contamination level can be set based on the above criteria for a typical crude sample. If the calculated contamination level exceeds this maximum allowable level, then the samples is considered to be too contaminated to accurately analyze. For acetone in crudes, a maximum allowable contamination level of 0.25% level can be used based an estimated 4-5% change in viscosity for medium API crudes.

For each contaminant used as a reference, a maximum allowable level is set. If the calculated level of the contaminant is less than the allowable level, assay predictions can still be made, and uncertainties estimated based on the Fit Quality Ratio. Above this maximum allowable level, assay predictions may be less accurate due to the presence of the contaminant.

If multiple contaminants are used as references, a maximum combined level may be set. If the combined contamination level is less than the maximum combined level, assay predictions can still be made, and uncertainties estimated based on the Fit Quality Ratio. Above this maximum combined level, assay predictions may be less accurate due to the presence of the contaminants.

Analysis Scheme:

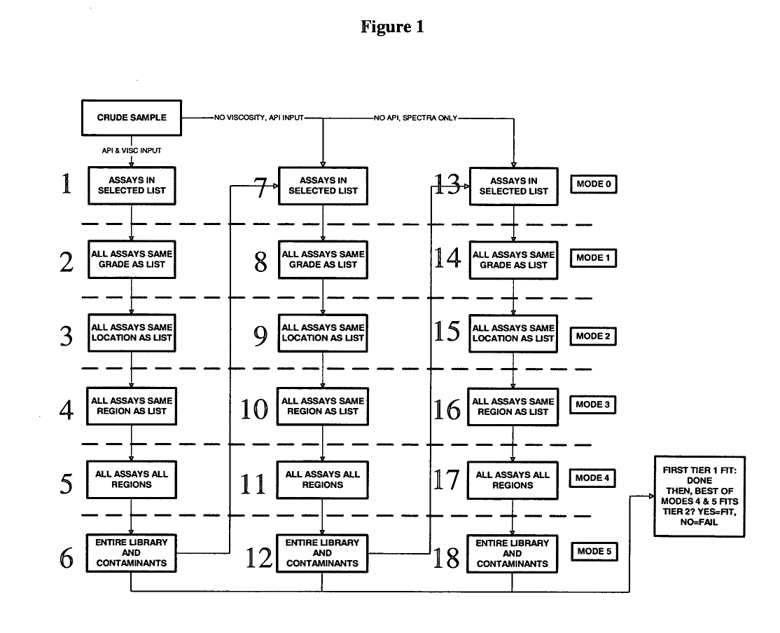

If the function f(c, f, i) in [19] is close to unity (e.g. the value of ε in [20] is close to zero), then FQ will tend to decrease as more components are added to the blend, and analyses done with larger subsets of references will tend to produce lower FQ values. In this case, for the application of this invention to the prediction of crude assay data, the “First Tier 1 Fit” scheme depicted in FIG. 1 has been found to yield reasonable prediction quality. For simplicity only analyses based on FT-IR only, FT-IR and API, or FT-IR, API and viscosity are shown. If analyses for FT-IR and viscosity were also used, a separate column would be added to the scheme in the figure.

Assuming that the API Gravity and viscosity for the unknown have been measured, the analysis scheme starts at point 1. The user may supply a specific set of references to be used in the analysis. Fits are conducted according to the three steps described herein above. Although an FT-IR only based fit (step 1) and an FT-IR & API based fit (step 2) are calculated, they are not evaluated at this point. If the fit based on FT-IR, API Gravity and viscosity produces a Tier 1 fit, the analysis is complete and the results are reported.

If the analysis at point 1 does not produce a Tier 1 fit, then the process proceeds to point 2. The reference set is expanded to include all references that are of the same crude grade(s) as the initially selected crudes. The three-step analysis is again conducted, and the analysis based on FT-IR, API Gravity and viscosity is examined. If this analysis produces a Tier 1 fit, the analysis is complete and the results are reported.

If the analysis at point 2 does not produce a Tier 1 fit, then the process proceeds to point 3. The reference set is expanded to include all references that are from the same location(s) as the initially selected crudes. The three-step analysis is again conducted, and the analysis based on FT-IR, API Gravity and viscosity is examined. If this analysis produces a Tier 1 fit, the analysis is complete and the results are reported.

If the analysis at point 3 does not produce a Tier 1 fit, then the process proceeds to point 4. The reference set is expanded to include all references that are from the same region(s) as the initially selected crudes. The three-step analysis is again conducted, and the analysis based on FT-IR, API Gravity and viscosity is examined. If this analysis produces a Tier 1 fit, the analysis is complete and the results are reported.

If the analysis at point 4 does not produce a Tier 1 fit, then the process proceeds to point 5. The reference set is expanded to include all references crudes. The three-step analysis is again conducted, and the analysis based on FT-IR, API Gravity and viscosity is examined. If this analysis produces a Tier 1 fit, the analysis is complete and the results are reported.

If the analysis at point 5 does not produce a Tier 1 fit, then the process proceeds to point 6. The reference set is expanded to include all references crudes and contaminants. The three-step analysis is again conducted, and the analysis based on FT-IR, API Gravity and viscosity is examined. If this analysis produces a Tier 1 fit, the analysis is complete and the results are reported, and the sample is reported as being contaminated. If the contamination does not exceed the maximum allowable level, assay results may still be calculated and Confidence Intervals estimated based on the fit FQR. If the contamination does exceed the allowable level, the results may be less accurate than indicated by the FQR.

If the analysis at point 6 does not produce a Tier 1 fit, then the fits based on FT-IR and API Gravity (from Steps 2 at each points) are examined to determine if any of these produce Tier 1 fits. The fit for the selected references are examined first (point 7). If this analysis produced a Tier 1 fit, the analysis is complete and the results are reported. If not, the process continues to point 8, and the fit based on crudes of the same grade(s) as the selected crudes using FT-IR and API Gravity are examined. The process continues checking fits for point 9 (crudes of same location(s)), point 10 (crudes of same region(s)), point 11 (all crudes) and point 12 (all crudes and contaminants), stopping if a Tier 1 fit is found or otherwise continuing. If not Tier 1 fit is found using FT-IR and API Gravity, FT-IR only fits (from Step 1 at each point) are examined, checking fits for point 13 (selected references), point 14 (same grades), point 15(same locations), point 16 (same regions), point 17 (all crudes) and point 18 (all crudes and contaminants), stopping if a Tier 1 fit is found or otherwise continuing.

If no Tier 1 fit is found, the analysis that produces the highest FQR value is selected and reported. If the FQR value is less than or equal to 1.5, the result is reported as a Tier 2 fit. Otherwise, it is reported as a failed fit.

If Viscosity data is not available, the analysis scheme would start at point 7 and continue as discussed above. If neither viscosity nor API gravity was available, the analysis scheme would start at point 15 and continue as discussed above.

If the function f (c, f, i) in [19] is not close to unity (e.g. the value of ε in [20] is for instance 0.25), then FQ will not necessarily decrease as more components are added to the blend, and analyses done with larger subsets of references may not produce lower FQ values. In this case, for the application of this invention to the prediction of crude assay data, a “Best Fit” scheme may yield more reasonable prediction quality.

If API gravity and viscosity data are both available, the analyses 1-6 of column 1 in FIG. 1 are evaluated, and the analysis producing the lowest FQR is selected as the best fit. If the FQR value for the best fit is less than 1, the analysis is complete and the results are reported.

If the best fit obtained using API Gravity and viscosity is not a Tier 1 fit, then the analyses 7-12 of column 2 in FIG. 1 are evaluated, and the analysis producing the lowest FQR is selected as the best fit. If the FQR value for the best fit is less than 1, the analysis is complete and the results are reported.

If the best fit obtained using API Gravity is not a Tier 1 fit, then the analyses 13-18 of column 3 in FIG. 1 are evaluated, and the analysis producing the lowest FQR is selected as the best fit. If the FQR value for the best fit is less than 1, the analysis is complete and the results are reported.

If none of the analyses produce a Tier 1 fit, then the analysis producing the lowest FQR value is selected and reported. If the FQR is less than 1.5, the results are reported as a Tier 2 fit, otherwise as a failed fit.

Library Cross Validation:

In order to evaluate and optimize the performance of a reference library, a cross validation procedure is used. In an iterative procedure, a reference is removed from the library and analyzed as if it were an unknown. The reference is then returned to the library. This procedure is repeated until each reference has been left out and analyzed once.

The cross validation procedure can be conducted to simulate any point in the analysis scheme. Thus for instance, the cross validation can be done using both API Gravity and viscosity as inspection inputs, and only using references from the same location as the reference being left out (simulation of point 3).

Reference Library Optimization:

In order for the analyses for a given FQR to produce comparable assay predictions regardless of inspection inputs or reference subset selection, it is necessary to carefully optimize the FQC values and inspection weightings. This optimization can be accomplished in the following manner:

For FT-IR only analyses:
I. A minimum performance criteria is set.
II. For analyses conducted using FT-IR only, cross validation analyses are performed to simulate points 13-17 in the analysis scheme. The results for these points are combined, and the Fit Quality (FQ) is calculated for each result.

Selected assay properties are predicted based on each fit.
III. The results are sorted in order of increasing Fit Quality (FQ).
IV. In turn, each FQ value is selected as a tentative FQC, and tentative FQR values are calculated. For each crude, a determination is made as to at which point (13-17) the analysis would have ended. The results corresponding to these stop points are collected, and statistics for the assay predictions are calculated. These results are referred to as the iterative results for this tentative FQC.
V. The maximum FQ value that meets the minimum performance criteria is selected as the FQC_{IR}.
VI. The iterative results from step IV are representative of the results that would be obtained from the analysis with the indicated FQC.

For analyses using FT-IR and inspections:
VII. A set of assay properties is selected for which the predictions are to be matched to those from the FT-IR only analyses.
VIII. Criteria for fit to the inspection data are set.
IX. An initial estimate is made for the inspection weights.
X. Cross validation analyses are performed to simulate points 1-5 or 7-11. The results for these points are combined and the Fit Quality (FQ) is calculated for each result. Selected assay properties are predicted based on each fit.
XI. The results are sorted in order of increasing Fit Quality (FQ).
XII. In turn, each FQ value is selected as a tentative FQC, and tentative FQR values are calculated. For each crude, a determination is made as to at which point (1-5 or 7-11) the analysis would have ended. The results corresponding to these stop points are collected, and statistics for the assay predictions are calculated. These results are referred to at the iterative results for this tentative FQC.
XIII. The statistics for the assay predictions made using the FT-IR and inspections are compared to those based on FT-IR only. The maximum FQ value for which the predictions are comparable is selected as the tentative FQC_{IR,API} or FQC_{IR.API,visc}.
XIV. The fits to the inspection data are examined statistically and compared to the established criteria. If the statistics match the established criteria, then the tentative FQC_{IR,API} or FQC_{IR.API,visc} values are accepted. If not, then the inspection weightings are adjusted and 9-13 are repeated.
XV. The iterative results from step XII are representative of the results that would be obtained from the analysis with the indicated FQC and inspection weightings.

Various statistical measures can be used to evaluate the library performance and evaluate the fits to the inspections. These include, but are not limited to:
The standard error of cross validation for the prediction of the assay properties for Tier 1 fits. t(p,n) is the t statistic for probability level p and n degrees of freedom. The summation is calculated over the n samples that yield Tier 1 fits.

$$t \cdot SECV = t ( p , n ) \cdot \sqrt{\frac{{\sum }_{i = 1}^{n} {( {\hat{y}}_{i} - {y}_{i} )}^{2}}{n}} \qquad [ 27 ]$$
The confidence interval at FQR=1.
The percentage of predictions for Tier 1 fits for which the difference between the prediction and measured property is less than the reproducibility of the measurement.

Note that the fits for steps 6, 12 and 18 are not included in the library optimization since the reference crudes do not contain contaminants.

Calculation of Confidence Intervals:

For the inspections included in the fit, the confidence intervals (CI) are defined only in terms of the FQR. The following procedures is used to calculate confidence intervals for included inspections:

Absolute Error CI for Inspections (e.g. API Gravity).
For each of the n iterative results from step XV above, calculate the difference between the inspection predicted from the fit, and the input (measured) inspection value, dᵢ=ŷᵢ−yᵢ.
Divide the dᵢ by \sqrt{1−Rᵢ²}.
Calculate the root mean of these scaled results.

$$s = \sqrt{\frac{{\sum }_{i = 1}^{n} \frac{{d}_{i}^{2}}{( 1 - {R}_{i}^{2} )}}{n}} .$$
Calculate the t value for the desired probability level and n degrees of freedom.
The Confidence Interval is then given by equation [25].

Relative Error CI for Inspections (e.g. Viscosity).
For each of the n iterative results from step XV above, calculate the relative difference between the inspection predicted from the fit, and the input (measured) inspection value,

$${r}_{i} = \frac{{\hat{y}}_{i} - {y}_{i}}{{\hat{y}}_{i} + {y}_{i} / 2} .$$
Divide the rᵢ by √1−Rᵢ².
Calculate the root mean of these scaled results,

$$s = \sqrt{\frac{{\sum }_{i = 1}^{n} \frac{{r}_{i}^{2}}{( 1 - {R}_{i}^{2} )}}{n}} .$$
Calculate the t value for the desired probability level and n degrees of freedom.
The Confidence Interval is then given by equation [26].

Absolute Error for Assay Predictions:
The estimation of the a and b parameters are made using all of the results from the cross-validation analysis (points 1-5, points 7-11 or points 13-17).
For each of the m results from the cross validation analysis, calculate the difference, dᵢ, between the predicted and measured assay property value; dᵢ=ŷᵢ−yᵢ.
For an initial estimate of a and b, calculate

$${δ}_{i} = \sqrt{{FQR}^{2} + {( a + b ( \frac{{\hat{y}}_{i} + {y}_{i}}{2} ) )}^{2}}$$

for each of the m results.
For each result, calculate the ratio d₁/δᵢ.
For the distribution of the m ratios, calculate a statistic that is a measure of the normality of the distribution. Such statistics include, but are not limited to the Anderson-Darling statistic, and the Lilliefors statistic, the Jarque-Bera statistic or the Kolmogorov-Smimov statistic. The values of a and b are adjusted to maximize the normality of the distribution based on the calculated normality statistic. For the Anderson-Darling statistic, this involves adjusting a and b so as to minimize the statistic.
For each of the n iterative results, calculate the difference, dᵢ, between the predicted and measured assay property value; dᵢ=ŷᵢ−yᵢ.
Using the a and b values determined above, calculate

$${δ}_{i} = \sqrt{{FQR}^{2} + {( a + b ( \frac{{\hat{y}}_{i} + {y}_{i}}{2} ) )}^{2}}$$

for each of the n iterative results.
Calculate the root mean of the scaled differences,

$$s = \sqrt{\frac{{\sum }_{i = 1}^{n} {( \frac{{d}_{i}}{{δ}_{i}} )}^{2}}{n}} .$$
Calculate the t statistic for the desired probability level and n degrees of freedom
The Confidence Interval is then given by equation [23].

If the reproducibility of the reference property measurement is independent of level, the parameter b may be set to zero and only the parameter a is adjusted.
Other, more complicated expressions could be substituted for f(E_{ref}), and optimized in the same fashion as described above. For example, for methods with published reproducibilities, f(E_{ref}) could be expressed in the same functional form as the published reproducibility.

Relative Error for Assay Predictions:
The estimation of the a parameters is made using all of the results from the cross-validation analysis (points 1-5, points 7-11 or points 13-17).

For each of the m results from the cross validation analysis, calculate the relative difference, rᵢ, between the predicted and measured assay property value;

$${r}_{i} = \frac{{\hat{y}}_{i} - {y}_{i}}{( {\hat{y}}_{i} + {y}_{i} ) / 2} .$$

For an initial estimate of a and b, calculate δᵢ=\sqrt{FQR²+a²} for each of the m results.
For each result, calculate the ratio dᵢ/δᵢ.
For the distribution of the m ratios, calculate a statistic that is a measure of the normality of the distribution. Such statistics include, but are not limited to the Anderson-Darling statistic, and the Lilliefors statistic, the Jarque-Bera statistic or the Kolmogorov-Smirnov statistic. The values of a and b are adjusted to maximize the normality of the distribution based on the calculated normality statistic. For the Anderson-Darling statistic, this involves adjusting a and b so as to minimize the statistic.
For each of the n iterative results, calculate the relative difference, rᵢ, between the predicted and measured assay property value;

$${r}_{i} = \frac{{\hat{y}}_{i} - {y}_{i}}{( {\hat{y}}_{i} + {y}_{i} ) / 2} .$$
Using the a and b values determined above, calculate δᵢ=\sqrt{FQR²+a²} for each of the n iterative results.
Calculate the root mean of the scaled differences,

$$s = \sqrt{\frac{{\sum }_{i = 1}^{n} {( \frac{{d}_{i}}{{δ}_{i}} )}^{2}}{n}} .$$
Calculate the t statistic for the desired probability level and n degrees of freedom.
The Confidence Interval is then given by equation [23].
If the reproducibility of the reference property measurement is independent of level, the parameter b may be set to zero and only the parameter a is adjusted.
Other, more complicated expressions could be substituted for f(E_{ref}), and optimized in the same fashion as described above. For example, for methods with published reproducibilities, f(E_{ref}) could be expressed in the same functional form as the published reproducibility.

### EXAMPLES

For prediction of crude assay data, yields can be used as the critical set of assay properties. Table 1 lists a set of crude distillation cuts. Distillation yields for these cuts could be used as the critical properties for determination of FQC and weightings. Cuts defined to other start/endpoints, or other assay properties could also be used.

TABLE 1
Distillation Cut Definitions for Examples

| Cut Name | Cut Start Point in ° F. | Cut End Point in ° F. |
|---|---|---|
| Light Naphtha | Initial boiling point | 160 |
| Medium Naphtha | 160 | 250 |
| Heavy Naphtha | 250 | 375 |
| Kerosene | 320 | 500 |
| Jet | 360 | 530 |
| Diesel | 530 | 650 |
| Light Gas Oil | 530 | 700 |
| Light Vacuum Gas Oil | 700 | 800 |
| Medium Vacuum | 800 | 900 |
| Gas Oil | | |
| Heavy Vacuum Gas Oil | 900 | 1050 |
| Atmospheric Resid | 650 | end |
| Vacuum Resid 1 | 900 | end |
| Vacuum Resid 2 | 1050 | end |

### Example 1

Example 1 uses the method of U.S. Pat. No. 6,662,116 B2 with separate tolerances for the fit to the FT-IR spectrum, and the API Gravity and viscosity inspection inputs.

A Virtual Assay library was generated using FT-IR spectra of 562 crude oils, condensates and atmospheric resids, and 10 acetone contaminant spectra. Spectra were collected at 2 cm⁻¹ resolution. Samples were maintained at 65° C. during the measurement. Data in the 4685.2-3450.0, 2238.0-1549.5 and 1340.3-1045.2 cm⁻¹ spectral regions were used in the analysis. The spectra are orthogonalized to polynomials in each spectral region to eliminate baseline effects. Five polynomial terms (quartic) are used in the upper spectral region, and 4 polynomial terms (cubic) in the lower two spectral regions. The spectra are also orthogonalized to water difference spectra that are smoothed to minimize introduction of spectral noise, and to water vapor spectra. These corrections minimize the sensitivity of the analysis to water in the crude samples, and to water vapor in the instrument purge.

A cross-validation analysis is conducted on the 562 crude oil, condensate and atmospheric resid spectra. Analyses are conducted using all samples as references. API gravity and viscosity at 40° C. are used as inspection inputs. Viscosity is blended using the Viscosity Blend Index method and the alternate step 3 in the algorithm. Analyses are conducted using only FT-IR data, using FT-IR in combination with API Gravity, and using FT-IR in combination with both API Gravity and viscosity. For analyses using FT-IR and API Gravity, a in equation 17 is set to 2.307. For analyses using FT-IR, API Gravity and viscosity, the α in equation 17 is set to 2.92125 for API Gravity and 4.578727 for viscosity.

The minimum R² value for the fit to the FT-IR data is set to 0.99963 such that the cross-validation error(t·SECV) for predicting Atmospheric Resid yield is approximately 3% absolute. The tolerance for API Gravity is set to 0.5, the reproducibility of the ASTM D287 method. ASTM D445, which is used to obtain the viscosity data does not list reproducibility data for crude oils, so it is assumed to be on the order of 7% relative for these calculations.

Table 2 shows the results of the cross-validation analysis. When using only FT-IR in the analysis, 270 of the samples are fit to better than the R² tolerance. When FT-IR is used in combination with API Gravity or API Gravity and viscosity, fewer samples pass the combined tolerances, but the accuracy of the predictions improves. The improvement in the prediction accuracy is further confirmed when comparisons are made on the basis of the same set of 270 samples (columns 5 and 6 of Table 2). The addition of the inspection data adds constraints to the least square fit, making it more difficult to achieve the same goodness of fit, but makes it easier to achieve an accurate assay prediction.

### Example 2

For Example 2, the same data as was used in Example 1 is again used, but in this case the method of the current invention is employed to balance the relative prediction power of analyses made using different inspection inputs. Future, analyses are conducted using the Grade/Location/Region/All Crudes iteration scheme.

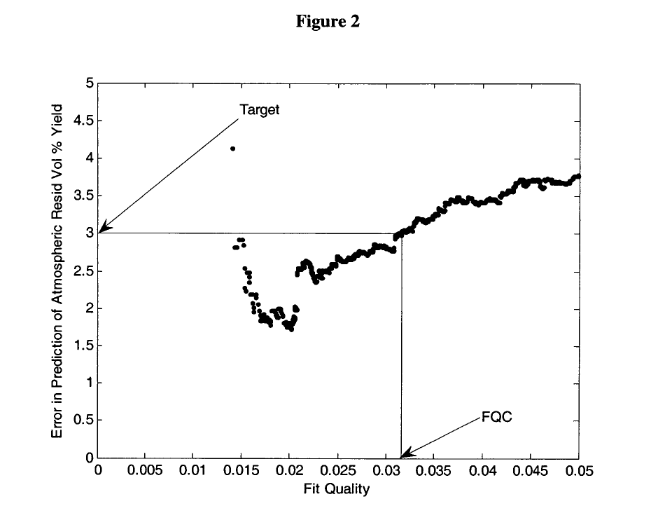

For the analysis using FT-IR only, the FQC is set such that the error (t·SECV) in the prediction of the atmospheric resid yield is approximately 3 volume percent. A “same grade” cross-validation analysis is conducted limiting the references used to crudes of the same grade as the crude left out for analysis. 312 crudes in the library can be analyzed in this fashion. A “same location” cross-validation analysis is repeated using crudes from the same location as the crude that is left out as references. 545 of the crudes in the library can be analyzed in this fashion. The cross-validation is repeated using crudes from the “same region” as the crude left out (562 fits), and using “all crudes” (562 fits). The fits and results for all four set of analyses are combined, and sorted based on the Fit Quality (FQ). Starting at the lowest FQ value, each FQ value is evaluated as a potential Fit Quality Cutoff (FQC). For a potential FQC and each crude, the Tier 1 fit with the smallest set of references (Grade<Location<Region<All Crudes) is selected, and the error for the prediction of atmospheric resid yield based on these Tier 1 fits is calculated. The results of this process are shown in FIG. 2. The highest FQ value that produces an error less than or equal to 3% is selected as FQC.

The FQC values for the analyses done using FT-IR and API Gravity, and FT-IR, API Gravity and viscosity are set such that the Root Mean Square (RMS) error for the yields of the indicated cuts is as similar as possible to the RMS error for the analyses based on FT-IR alone. The a parameters are adjusted such that the error (t·SECV) in the fit to the API Gravity and viscosity inputs are approximately 0.5 and 7% relative respectively. FQC and a are calculated via an iterative optimization procedure. For a candidate a value, cross-validation analyses for “same grade”, “same location”, “same region” and “all crudes” are conducted as discussed above. The fits and results are sorted based on FQ. Starting at the lowest FQ value, each FQ value is evaluated as a potential Fit Quality Cutoff (FQC). For a potential FQC and each crude, the Tier 1 fit with the smallest set of references (Grade<Location<Region<All Crudes) is selected, and the Root Mean Square (RMS) error for the prediction of yields for the selected distillation cuts based on these Tier 1 fits is calculated. The FQ value that produces an RMS yield error that is closest to the RMS error for the analyses based on FT-IR alone is selected as the FQC value for this candidate α. An optimization value is calculated for this value of α as:

For fits using FT-IR and API Gravity:

$$OV ( α ) = {( \frac{t \cdot {SECV}_{API} - 0.5}{0.5} )}^{2} \qquad [ 28 ]$$

For fits using FT-IR, API Gravity and viscosity:

$$OV ( α ) = {( \frac{t \cdot {SECV}_{API} - 0.5}{0.5} )}^{2} + {( \frac{t \cdot {SECV}_{visc} - 0.07}{0.07} )}^{2} \qquad [ 29 ]$$

The parameter(s) α is adjusted to minimize OV(α) using standard nonlinear optimization methods such as the fminsearch routine in MATLAB® (Mathworks, Inc.).

The results of the cross-validation analysis are shown in Table 3. For Tier 1 fits, the root-mean-square yield error calculated over the indicated distillation cuts is 1.75 volume % in each case. The errors for the prediction of the individual cuts varies slightly, but the overall quality of the yield predictions is comparable regardless of whether or which inspection inputs are used. The error in the calculated API Gravity and viscosity is of course smaller when these inspections are used as inputs to the fit. Viscosities at temperatures other than that used as an input are also predicted better when viscosity is used as an input. However, the quality of other assay property predictions are comparable in all three cases. Thus the method of the current invention can be seen to provide a single statistical measure of the quality of the predictions regardless of the inspection inputs that are used.

### Example 3

The same data used in Examples 1 and 2 are analyzed using only FT-IR. In one case, the method of U.S. Pat. No. 6,662,116 B2 is used. In the second case, the method of the current invention is used. Cross-validation analyses are done using references of the “same grade” as the crude being analyzed, using references of the “same location”, using references of the “same region” and using “all crudes”. For the analyses conducted using the method of U.S. Pat. No. 6,662,116 B2, a R² tolerance is set to 0.99963. For each set of cross-validation analyses, fits for which R² is greater than or equal to this tolerance value are collected, and used to calculate prediction errors for yields and assay properties. For the cross-validation analyses conducted using the method of the current invention, a FQC value of 0.031677 is used to define Tier 1 analyses, the results for these Tier 1 analyses are collected, and used to calculate prediction errors for these same yields and assay properties. The results are shown in Table 4.

In comparing the results for the fixed R² tolerance criterion (columns 2-5 in Table 4) to the results for the Fit Quality criterion of the current invention (columns 7-10 in Table 5), it can be seen that the Fit Quality based analysis is more likely to find acceptable fits based on subsets than the fixed tolerance based method. With the fixed R² tolerance method, the prediction errors for fits that meet the tolerance criterion are generally smaller if a smaller subset is used. With the Fit Quality based method of the current invention, the prediction errors are generally comparable regardless of subset size.

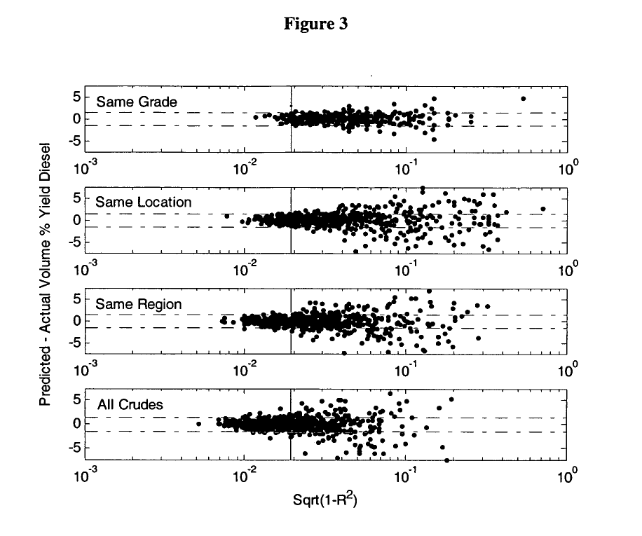

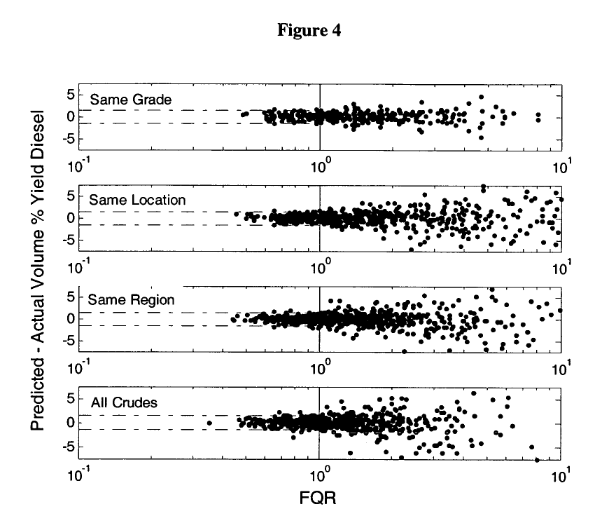

FIGS. 3 and 4 further illustrate this point using data for prediction of Atmospheric Resid Volume % Yield based on analyses using FT-IR without inspections. In FIG. 3, the vertical line on each graph represents the fixed R² tolerance, and the horizontal dashed lines represent the reproducibility of the reference distillation method. Points to the left of the vertical lines represent the predictions from fits that pass the R² tolerance criterion, and points to the right of the line are fits that fail this criterion. From the graphs for fits using “Same Grade” (top) and “Same Location” (2nd from top), it can be seen that numerous fits that fail to meet the R² tolerance produce predictions that are within the reproducibility of the distillation. In FIG. 4, the vertical lines represent the point at which FQR equals 1. A significantly larger number of the “Same Grade” and “Same Location” fits for which the predictions are within the horizontal lines now fall to the left side of the vertical cutoff line. The magnitude of the prediction errors for the Tier 1 fits (points to the left of the vertical cutoffs) are comparable regardless of the reference subsets used in the analysis.

### Example 4

Example 4 demonstrates how different performance criteria can be used in the method of the current invention. The same data as was used in Example 2 is again used, but in this case, performance criteria based on Confidence Intervals are used to establish cutoffs.

For the analysis using FT-IR only, the FQC is set such that the Confidence Interval for the prediction of the atmospheric resid yield is approximately 3 volume percent. A “same grade” cross-validation analysis is conducted limiting the references used to crudes of the same grade as the crude left out for analysis. 312 crudes in the library can be analyzed in this fashion. A “same location” cross-validation analysis is repeated using crudes from the same location as the crude that is left out as references. 545 of the crudes in the library can be analyzed in this fashion. The cross-validation is repeated using crudes from the “same region” as the crude left out (562 fits), and using “all crudes” (562 fits). The fits and results for all four sets of analyses are combined, and sorted based on the Fit Quality (FQ).

The Confidence Interval for Atmospheric Resid Volume % Yield is calculated using the procedure described herein above for Confidence Intervals based on Absolute Error for Assay Predictions. Since the reproducibility of the distillation yield is not level dependent, only the a parameter is calculated. The results from the four sets of cross-validation analyses are combined. For each of the m results from the combined cross-validation analyses, the difference, dᵢ, between the predicted and measured assay property value, dᵢ=ŷᵢ−yᵢ, is calculated. For an initial estimate of a, δᵢ=\sqrt{FQR²+a²} for each of the m results. For each of the m results, the ratio dᵢ/δᵢ is calculated. For the distribution of the m ratios, an Anderson-Darling statistic is calculated. The value of a is adjusted to maximize the normality of the distribution by minimizing the calculated Anderson-Darling statistic.

Starting at the lowest FQ value, each FQ value is evaluated as a potential Fit Quality Cutoff (FQC). For a potential FQC and each crude, the Tier 1 fit with the smallest set of references (Grade<Location<Region<All Crudes) is selected. For all crudes where no Tier 1 fit is obtained, the “all crudes” results is used. The Confidence Interval for the prediction of atmospheric resid yield based on these combined results is calculated. The root mean of the scaled differences,

$$s = \sqrt{\frac{{\sum }_{i = 1}^{n} {( \frac{{d}_{i}}{{δ}_{i}} )}^{2}}{n}}$$

for the n fits. The t statistic for the desired probability level and n degrees of freedom is calculated. The Confidence Interval is then given by [23]. The FQ value that produces a CI closest to 3% is selected as FQC.

The FQC values for the analyses done using FT-IR and API Gravity, and FT-IR, API Gravity and viscosity are set such that the Root Mean Square (RMS) difference between the CIs for the yields of the indicated cuts calculated using FT-IR and the inspections and the Cis calculated based of analyses using only FT-IR is as small as possible. The α parameters are adjusted such that the 95% of the values calculated for API Gravity and viscosity inputs based on the fits are within the 0.5 and 7% relative reproducibilities for these inspections. FQC and α are calculated via an iterative optimization procedure. For a candidate α value, cross-validation analyses for “same grade”, “same location”, “same region” and “all crudes” are conducted as discussed above. The fits and results are sorted based on FQ. Starting at the lowest FQ value, each FQ value is evaluated as a potential Fit Quality Cutoff (FQC). For a potential FQC and each crude, the Tier 1 fit with the smallest set of references (Grade<Location<Region<All Crudes) is selected. For any crude where a Tier 1 fit is not obtained, the “All Crudes” result is selected. The Confidence Interval is calculated for each of the distillation cuts based on the selected results. The FQ value that produces the smallest RMS yield error between these calculated CIs and the CIs based on FT-IR alone is selected as the FQC value for this candidate α. The fraction, FAPI, of the API Gravity values for the fits that are within 0.5 of the actual API Gravity is calculated. If viscosity is used, the fraction, F_{visc}, of the viscosity values for the fits that are within 7% relative of the actual viscosity are calculated. The difference between these calculated percentages and 95% is calculated and squared. The optimization value OV(α) is calculated as For fits using FT-IR and API Gravity,
OV(α)=(F_{API}−0.95)² [30]
For fits using FT-IR, API Gravity and viscosity:
OV(α)=(F_{API}−0.95)²+(F_{visc}−0.95)² [31]
The parameter(s) α is adjusted to minimize OV(α) using standard nonlinear optimization methods such as the fminsearch routine in MATLAB® (Mathworks, Inc.).

The results of the cross-validation analysis are shown in Table 5. The root-mean-square CI calculated over the indicated distillation cuts is between 1.88 and 1.90 in each case. The errors for the prediction of the individual cuts varies slightly, but the overall quality of the yield predictions is comparable regardless of whether or which inspection inputs are used. The error in the calculated API Gravity and viscosity is of course smaller when these inspections are used as inputs to the fit. Viscosities at temperatures other than that used as an input are also predicted better when viscosity is used as an input. However, the quality of other assay property predictions are comparable in all three cases. Thus the method of the current invention can be seen to provide a single statistical measure of the quality of the predictions regardless of the inspection inputs that are used.

### Example 5

The same FT-IR and inspection data as was used in the previous examples is again used, but in this case, viscosity is blended using the Viscosity Blend Index method and step 3 in the algorithm. The results FQC and α values are calculated using the same methodology as described herein above in Example 2. The results are shown in Table 6. The current invention provides comparable results regardless of the methodology used to blend viscosity data.

### Example 6

Example 6 demonstrates how a Confidence Interval is calculated for a property where the reference method reproducibility is level independent. Predictions of Atmospheric Resid Volume % Yield based on fits using only FT-IR are employed. Cross-validation analyses are conducted using “Same Grade”, “Same Location”, “Same Region”, and “All Crudes”. The predictions from all four sets of cross-validation analyses are combined. For each of the m results from the combined cross-validation analyses, the difference, dᵢ, between the predicted and measured assay property value, dᵢ=ŷᵢ−yᵢ, is calculated. For an initial estimate of a, δᵢ=\sqrt{FQR²+a²} for each of the m results. For each of the m results, the ratio dᵢ/δᵢ is calculated. For the distribution of the m ratios, an Anderson-Darling statistic is calculated. The value of a is adjusted to maximize the normality of the distribution by minimizing the calculated Anderson-Darling statistic. A value of 0.2617 for a is obtained in this fashion.

For each crude, the “iterate” results are selected from the combined cross-validation results. For crudes where one or more fit resulted in an FQR value of 1 or less, the Tier 1 fit based on the smallest subset is selected. For crudes where no fit resulted in a Tier 1 fit, the “all crudes” fit is selected. The root mean of the scaled differences,

$$s = \sqrt{\frac{{\sum }_{i = 1}^{n} {( \frac{{d}_{i}}{{δ}_{i}} )}^{2}}{n}}$$

for the n “iterate” fits is calculated, yielding a value of 1.7303. The t statistic for the desired probability level and n degrees of freedom is calculated as 1.9642. The confidence interval is then given by CI=1.9642·1.7303\sqrt{FQR²+0.2617²}.

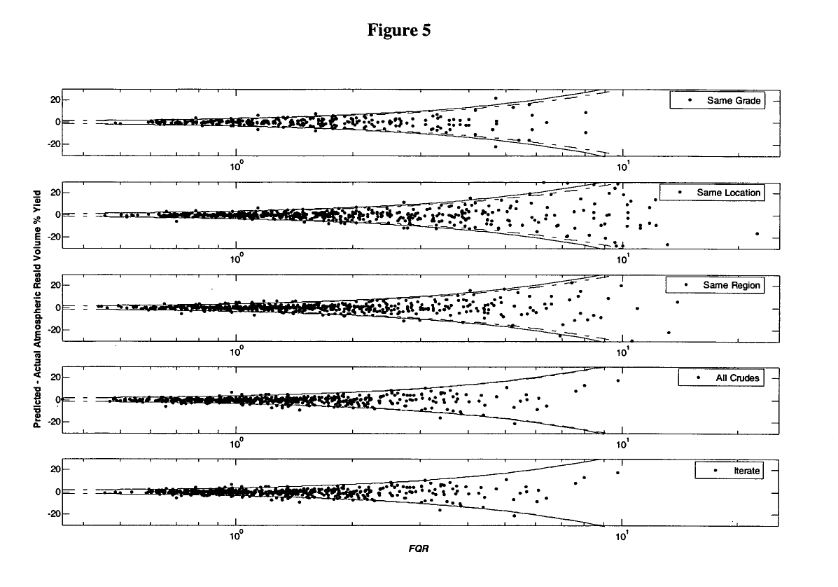

The confidence interval is shown graphically in FIG. 5. The solid curves representing the CI given above can be seen to adequately represent the distribution of prediction errors regardless of the size of the reference subset used in the analysis. The CI calculated as described above (solid curves) are comparable to those calculated using the cross-validation results for the difference subsets (dashed curves).

### Example 7

Example 7 demonstrates how a Confidence Interval is calculated for a property where the reference method reproducibility is level dependent. Predictions of Weight % Sulfur based on fits using FT-IR, API Gravity and viscosity at 40° C. are employed. FQC and a values were adjusted as described in Example 2. Cross-validation analyses are conducted using “Same Grade”, “Same Location”, “Same Region”, and “All Crudes”. The predictions from all four sets of cross-validation analyses are combined. For each of the m results from the combined cross-validation analyses, the difference, dᵢ, between the predicted and measured assay property value, dᵢ=ŷᵢ−yᵢ, is calculated, as is the average of the predicted and measured assay property,

$${X}_{i} = \frac{{\hat{y}}_{i} + {y}_{i}}{2} .$$

For initial estimates of a and b, δᵢ=\sqrt{FQRᵢ²+(a+bXᵢ)²} is calculated for each of the m results. For each of the m results, the ratio dᵢ/δᵢ is calculated. For the distribution of the m ratios, an Anderson-Darling statistic is calculated. The value of a is adjusted to maximize the normality of the distribution by minimizing the calculated Anderson-Darling statistic. Values of 0.0650 and 0.7099 are obtained in this fashion for a and b respectively.

For each crude, the “iterate” results are selected from the combined cross-validation results. For crudes where one or more fit resulted in an FQR value of 1 or less, the Tier 1 fit based on the smallest subset is selected. For crudes where no fit resulted in a Tier 1 fit, the “all crudes” fit is selected. The root mean of the scaled differences,

$$s = \sqrt{\frac{{\sum }_{i = 1}^{n} {( \frac{{d}_{i}}{{δ}_{i}} )}^{2}}{n}}$$

for the n “iterate” fits is calculated, yielding a value of 0.0693. The t statistic for the desired probability level and n degrees of freedom is calculated as 1.9642. The confidence interval is then given by

$$CI = 1.9642 \cdot 0.0693 \sqrt{{FQR}^{2} + {( 0.0650 + 0.7099 \frac{( \hat{y} + y )}{2} )}^{2}} .$$

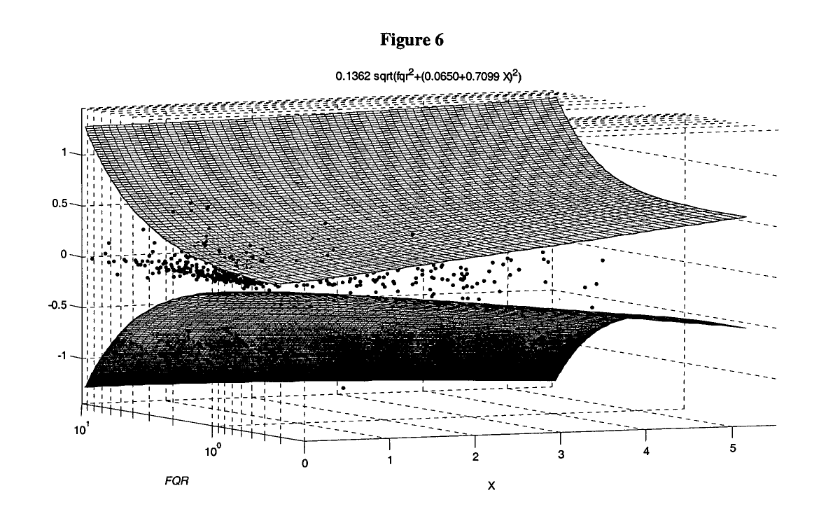

The confidence interval is shown graphically in FIG. 6. The CI is a function of both FQR and the property level, thus appearing as two surfaces in the graph. Points between the surfaces are predicted to within the CI.

TABLE 2
Data for Example 1

| | | | | FT-IR, |
|---|---|---|---|---|
| | | | | API |
| | | | FT-IR & | Gravity |
| | | | API | & |
| | | | Gravity | Viscosity |
| | | | Same | Same |
| | | FT-IR, | 270 | 270 |
| | | API | Samples | Samples |
| | FT-IR & | Gravity | as | as |
| FT-IR | API | & | FT-IR | FT-IR |
| Only | Gravity | Viscosity | Only | Only |

Tolerances

| | | | | | |
|---|---|---|---|---|---|
| Min R2 for IR | 0.99963 | 0.99963 | 0.99963 | | |
| Max API Difference | | 0.5 | 0.5 | | |
| Max Viscosity Difference | | | 7% | | |
| Number of Fits Meeting Tolerance | 270 | 237 | 204 | | |
| RMS Yield Error | 1.77 | 1.51 | 1.49 | 1.59 | 1.61 |
| Yield Errors (Volume %) | | | | | |
| LVN | 1.92 | 1.51 | 1.45 | 1.68 | 1.74 |
| MVN | 1.56 | 1.24 | 1.32 | 1.40 | 1.44 |
| HVN | 1.61 | 1.52 | 1.52 | 1.62 | 1.62 |
| KERO | 1.83 | 1.74 | 1.73 | 1.81 | 1.83 |
| JET | 1.61 | 1.54 | 1.50 | 1.58 | 1.60 |
| DIESEL | 1.37 | 1.36 | 1.32 | 1.38 | 1.44 |
| LTGO | 1.83 | 1.79 | 1.78 | 1.84 | 1.91 |
| LVGO | 0.92 | 0.86 | 0.89 | 0.90 | 0.94 |
| MVGO | 0.86 | 0.78 | 0.81 | 0.80 | 0.82 |
| HVGO | 1.08 | 0.97 | 0.97 | 0.99 | 1.04 |
| Atm. Resid | 2.98 | 2.13 | 2.13 | 2.28 | 2.26 |
| Vac. Resid 1 | 1.88 | 1.61 | 1.55 | 1.71 | 1.65 |
| Vac. Resid 2 | 2.35 | 1.89 | 1.81 | 2.00 | 1.95 |

TABLE 3
Data for Example 2

| | | | FT-IR, |
|---|---|---|---|
| | FT-IR | FT-IR & | API Gravity |
| | Only | API Gravity | & Viscosity |
| FQC | 0.031677 | 0.006491 | 0.006866 |
| a | | | |
| API | 0 | 3.4741 | 3.5450 |
| Viscosity at 40 C. | 0 | 0 | 5.6054 |
| Number of Tier 1 Fits | 229 | 278 | 278 |
| Number of Tier 2 Fits | 147 | 118 | 111 |
| RMS Yield Error | 1.75 | 1.75 | 1.75 |
| Yield Errors (Volume %) for Tier 1 Fits | | | |
| LVN | 2.06 | 2.00 | 1.89 |
| MVN | 1.43 | 1.56 | 1.48 |
| HVN | 1.62 | 1.78 | 1.66 |
| KERO | 1.81 | 2.01 | 2.13 |
| JET | 1.53 | 1.78 | 1.86 |
| DIESEL | 1.33 | 1.51 | 1.55 |
| LTGO | 1.81 | 1.99 | 2.11 |
| LVGO | 0.90 | 0.93 | 1.09 |
| MVGO | 0.92 | 0.87 | 0.90 |
| HVGO | 1.29 | 1.12 | 1.23 |
| Atm. Resid | 2.98 | 2.44 | 2.40 |
| Vac. Resid 1 | 1.80 | 1.84 | 1.72 |
| Vac. Resid 2 | 2.19 | 2.14 | 2.05 |
| Fit to Inspection Inputs (Tier 1 Fits) | | | |
| API Error | 1.43 | 0.50 | 0.50 |
| Viscosity @ 40 C. Relative Error | 24.5% | 19.6% | 7.0% |
| Prediction of Assay Properties | | | |
| for Tier 1 Fits | | | |
| Viscosity @ 25 C. Relative Error | 30.6% | 27.3% | 18.7% |
| Viscosity @ 50 C. Relative Error | 25.7% | 21.0% | 11.0% |
| Sulfur Wt % Error | 0.18 | 0.16 | 0.18 |
| Nitrogen Wt % Error | 0.05 | 0.05 | 0.05 |
| Conradson Carbon Error | 0.64 | 0.63 | 0.63 |
| Neutralization Number Error | 0.17 | 0.16 | 0.19 |

TABLE 4
Data for Example 2

| | | | FT-IR, |
|---|---|---|---|
| | FT-IR | FT-IR & | API Gravity |
| | Only | API Gravity | & Viscosity |
| FQC | 0.031677 | 0.006491 | 0.006866 |
| a | | | |
| API | 0 | 3.4741 | 3.5450 |
| Viscosity at 40 C. | 0 | 0 | 5.6054 |
| Number of Tier 1 Fits | 229 | 278 | 278 |
| Number of Tier 2 Fits | 147 | 118 | 111 |
| RMS Yield Error | 1.75 | 1.75 | 1.75 |
| Yield Errors (Volume %) for Tier 1 Fits | | | |
| LVN | 2.06 | 2.00 | 1.89 |
| MVN | 1.43 | 1.56 | 1.48 |
| HVN | 1.62 | 1.78 | 1.66 |
| KERO | 1.81 | 2.01 | 2.13 |
| JET | 1.53 | 1.78 | 1.86 |
| DIESEL | 1.33 | 1.51 | 1.55 |
| LTGO | 1.81 | 1.99 | 2.11 |
| LVGO | 0.90 | 0.93 | 1.09 |
| MVGO | 0.92 | 0.87 | 0.90 |
| HVGO | 1.29 | 1.12 | 1.23 |
| Atm. Resid | 2.98 | 2.44 | 2.40 |
| Vac. Resid 1 | 1.80 | 1.84 | 1.72 |
| Vac. Resid 2 | 2.19 | 2.14 | 2.05 |
| Fit to Inspection Inputs (Tier 1 Fits) | | | |
| API Error | 1.43 | 0.50 | 0.50 |
| Viscosity @ 40 C. Relative Error | 24.5% | 19.6% | 7.0% |
| Prediction of Assay Properties | | | |
| for Tier 1 Fits | | | |
| Viscosity @ 25 C. Relative Error | 30.6% | 27.3% | 18.7% |
| Viscosity @ 50 C. Relative Error | 25.7% | 21.0% | 11.0% |
| Sulfur Wt % Error | 0.18 | 0.16 | 0.18 |
| Nitrogen Wt % Error | 0.05 | 0.05 | 0.05 |
| Conradson Carbon Error | 0.64 | 0.63 | 0.63 |
| Neutralization Number Error | 0.17 | 0.16 | 0.19 |

TABLE 5
Data for Example 3

| | Method of US 6,662,116 B2 | | | | Method of Current Invention | | | |
|---|---|---|---|---|---|---|---|---|
| | Fixed R2 Cutoff | | | | Fit Quality based Cutoff | | | |
| | Same | Same | Same | All | Same | Same | Same | All |
| | Grade | Location | Region | Crudes | Grade | Location | Region | Crudes |
| Number of Analyses | 312 | 545 | 562 | 562 | 312 | 545 | 562 | 562 |
| Number of Fits Meeting Tolerance | 25 | 93 | 162 | 270 | 94 | 125 | 155 | 206 |
| Yield Errors (Volume %) | | | | | | | | |
| LVN | 2.04 | 2.02 | 2.19 | 2.32 | 2.12 | 2.07 | 2.00 | 1.85 |
| MVN | 1.25 | 1.59 | 1.63 | 1.90 | 1.25 | 1.39 | 1.37 | 1.47 |
| HVN | 1.45 | 1.57 | 2.10 | 2.16 | 1.44 | 1.33 | 1.44 | 1.52 |
| KERO | 1.69 | 1.96 | 2.21 | 2.30 | 1.71 | 1.55 | 1.65 | 1.76 |
| JET | 1.38 | 1.88 | 2.05 | 2.18 | 1.40 | 1.38 | 1.47 | 1.54 |
| DIESEL | 1.16 | 1.77 | 1.93 | 2.01 | 1.21 | 1.26 | 1.21 | 1.31 |
| LTGO | 1.58 | 2.33 | 2.52 | 2.64 | 1.65 | 1.66 | 1.53 | 1.76 |
| LVGO | 0.88 | 1.16 | 1.30 | 1.32 | 0.89 | 0.80 | 0.85 | 0.89 |
| MVGO | 0.90 | 0.92 | 1.03 | 1.16 | 0.93 | 0.80 | 0.79 | 0.82 |
| HVGO | 1.46 | 1.22 | 1.40 | 1.52 | 1.53 | 1.21 | 1.19 | 1.15 |
| Atm. Resid | 2.44 | 2.77 | 3.57 | 3.80 | 2.41 | 2.41 | 2.66 | 2.77 |
| Vac. Resid 1 | 1.79 | 2.05 | 2.40 | 2.59 | 1.84 | 1.85 | 1.64 | 1.84 |
| Vac. Resid 2 | 2.04 | 2.31 | 2.98 | 3.28 | 1.99 | 1.87 | 1.90 | 2.15 |
| Sulfur Wt % Error | 0.13 | 0.19 | 0.23 | 0.23 | 0.13 | 0.15 | 0.15 | 0.18 |
| Nitrogen Wt % Error | 0.07 | 0.05 | 0.05 | 0.04 | 0.07 | 0.03 | 0.05 | 0.04 |
| Conradson Carbon Error | 0.60 | 0.69 | 0.70 | 0.72 | 0.56 | 0.57 | 0.51 | 0.57 |
| Neutralization Number Error | 0.17 | 0.23 | 0.24 | 0.21 | 0.16 | 0.16 | 0.14 | 0.15 |

TABLE 6
Data for Example 4

| | | | FT-IR, |
|---|---|---|---|
| | | | API |
| | | | Gravity |
| | FT-IR | FT-IR & | & |
| | Only | API Gravity | Viscosity |
| FQC | 0.027288 | 0.007142 | 0.006186 |
| a | | | |
| API | 0 | 24.7238 | 33.3231 |
| Viscosity at 40 C. | 0 | 0 | 45.4311 |
| Number of Tier 1 Fits | 165 | 217 | 223 |
| Number of Tier 2 Fits | 147 | 125 | 123 |
| RMS CI | 1.89 | 1.90 | 1.88 |
| Confidence Interval at FQR = 1 | | | |
| LVN | 1.98 | 1.91 | 1.92 |
| MVN | 1.51 | 1.69 | 1.68 |
| HVN | 1.74 | 1.86 | 1.84 |
| KERO | 2.03 | 2.25 | 2.29 |
| JET | 1.85 | 2.07 | 2.11 |
| DIESEL | 1.55 | 1.58 | 1.66 |
| LTGO | 2.01 | 2.07 | 2.21 |
| LVGO | 1.00 | 1.01 | 1.17 |
| MVGO | 0.98 | 1.00 | 1.06 |
| HVGO | 1.40 | 1.32 | 1.40 |
| Atm. Resid | 3.00 | 2.76 | 2.36 |
| Vac. Resid 1 | 2.07 | 1.96 | 1.91 |
| Vac. Resid 2 | 2.46 | 2.33 | 2.20 |
| Fit to Inspection Inputs | | | |
| % of Tier 1 API Predictions < R | 64.2% | 94.9% | 95.1% |
| % of Tier 1 Visc 40 C. Predictions < R | 52.7% | 62.2% | 95.1% |
| CI for Prediction of Assay Properties | | | |
| Viscosity @ 25 C. Relative Error | 32.8% | 29.0% | 19.8% |
| Viscosity @ 50 C. Relative Error | 25.3% | 22.3% | 12.1% |
| Sulfur Wt % Error | 0.18 | 0.18 | 0.19 |
| Nitrogen Wt % Error | 0.05 | 0.04 | 0.05 |
| Conradson Carbon Error | 0.58 | 0.62 | 0.66 |
| Neutralization Number Error | 0.18 | 0.16 | 0.18 |

TABLE 7
Data for Example 5

| | | | FT-IR, |
|---|---|---|---|
| | | | API |
| | | FT-IR & | Gravity |
| | FT-IR | API | & |
| | Only | Gravity | Viscosity |
| FQC | 0.031677 | 0.006491 | 0.006572 |
| a | | | |
| API | 0 | 34.7414 | 40.6175 |
| Viscosity at 40 C. | 0 | 0 | 81.5966 |
| Number of Tier 1 Fits | 229 | 278 | 303 |
| Number of Tier 2 Fits | 147 | 118 | 109 |
| RMS Yield Error | 1.75 | 1.75 | 1.75 |
| Yield Errors (Volume %) | | | |
| LVN | 2.06 | 2.00 | 1.86 |
| MVN | 1.43 | 1.56 | 1.49 |
| HVN | 1.62 | 1.78 | 1.67 |
| KERO | 1.81 | 2.01 | 1.97 |
| JET | 1.53 | 1.78 | 1.74 |
| DIESEL | 1.33 | 1.51 | 1.57 |
| LTGO | 1.81 | 1.99 | 2.11 |
| LVGO | 0.90 | 0.93 | 1.10 |
| MVGO | 0.92 | 0.87 | 0.95 |
| HVGO | 1.29 | 1.12 | 1.22 |
| Atm. Resid | 2.98 | 2.44 | 2.37 |
| Vac. Resid 1 | 1.80 | 1.84 | 1.88 |
| Vac. Resid 2 | 2.19 | 2.14 | 2.18 |
| Fit to Inspection Inputs | | | |
| API Error | 1.43 | 0.50 | 0.50 |
| Viscosity @ 40 C. Relative Error | 25.8% | 20.1% | 7.0% |
| Prediction of Assay Properties | | | |
| Viscosity @ 25 C. Relative Error | 31.3% | 27.3% | 17.2% |
| Viscosity @ 50 C. Relative Error | 27.0% | 21.5% | 10.8% |
| Sulfur Wt % Error | 0.18 | 0.16 | 0.19 |
| Nitrogen Wt % Error | 0.05 | 0.05 | 0.05 |
| Conradson Carbon Error | 0.64 | 0.63 | 0.65 |
| Neutralization Number Error | 0.17 | 0.16 | 0.20 |

What is claimed is:

1. A method for determining an assay property of an unknown material comprising:
(a) determining multivariate analytical data and inspection data for said unknown material,
(b) fitting said multivariate analytical data alone and in combinations with said inspection data as linear combinations of subsets of known multivariate data and known inspection data in a database to determine sets of coefficients of linear combinations, wherein said database includes multivariate data and inspection data for reference materials whose assay properties are known,
(c) selecting from said linear combinations one linear combination with a fit quality better than a predetermined limit, and
(d) determining said assay property of said unknown from the coefficients of said selected linear combination and assay properties of the said references materials.

2. A method of claim 1 wherein said multivariate analytical data is a spectrum.

3. A method of claim 1 wherein said multivariate analytical data is an FT-IR spectrum.

4. A method of claim 1 wherein said inspection data is API gravity, viscosity or both.

5. A method of claim 1 wherein said material is a crude oil.

6. A method of claim 1 wherein said subsets include references that are of the same grade as said unknown.

7. A method of claim 1 wherein said subsets include references that are from the same geographical location, state or country as said unknown.

8. A method of claim 1 wherein said subsets include references that are from the same geographical region as said unknown.

9. A method of claim 1 wherein said fit quality of said linear combination is measured as the product of a function of the goodness-of-fit and a function of the number of nonzero coefficients.

10. A method of claim 9 wherein said goodness-of-fit function is the square root of one minus the multiple correlation coefficient, R².

11. A method of claim 9 wherein said function of the number of nonzero coefficients is the number of nonzero coefficient raised to a power.

12. A method of claim 11 wherein said power is 0.25.

13. A method for determining an assay property of an unknown material comprising:
in a library building mode:
(a) collecting multivariate analytical data for known reference materials,
(b) collection inspection data for known reference materials,
(c) measuring assay properties for known reference materials,
in a library optimization mode:
(d) for the multivariate analytical data of step (a) alone or in combination with the inspection data of step (b), and for subsets and the full set of the known references, conducting cross-validation analyses of the known reference materials to generate predictions of the said assay properties of step (c) for each reference,
(e) defining a fit quality statistic such that, for a given value of said fit quality statistic, the accuracy of assay predictions of step (d) are as similar as possible for predictions made using multivariate analytical data of step (a) alone or in combination with the inspection data of step (b), and for subsets and the full set of the known references, and:
in an analysis mode:
f) determining multivariate analytical data of said unknown material,
g) determining inspection data of said unknown material,
h) fitting said multivariate analytical data of step (f), alone and in combinations with said inspection data of step (g) to linear combinations of known multivariate analytical data for step (a) alone and in combinations with known inspection data from step (b) in a database to determine coefficients of the linear combinations, wherein said database includes multivariate analytical data and inspection data of reference materials whose assay properties are known,
(i) for each said linear combination of step (h), determining the said fit quality statistic of step (e)
(j) selecting from among said linear combinations a fit based on multivariate analytical data and inspections that meets or exceeds a predetermined fit quality criterion, and
(k) determining said assay property of said unknown material from the coefficients and assay properties of said reference materials.
